(19) United States
(12) Patent Application Publication
(10) Pub. No.: US 2023/0301298 A1
(43) Pub. Date: Sep. 28, 2023

(54) Biocide Compositions

(71) Applicant: BASF SE, Ludwigshafen Am Rhein (DE)

(72) Inventors: Rodney F. KLIMA, Cincinnati, OH (US); Dean A OESTER, Cincinnati, OH (US)

(21) Appl. No.: 18/003,380

(22) PCT Filed: Jun. 24, 2021
(86) PCT No.: PCT/EP2021/067358

§ 371 Date: Dec. 27, 2022

Related U.S. Application Data
(60) Provisional application No. 63/045,564, filed on Jun. 29, 2020.

(30) Foreign Application Priority Data
Jul. 28, 2020 (EP) 20188097.8

(51) Int. Cl. A01N 31/00; A01P 11/00; A01P 3/00; A01P 7/04; A01P 7/02; A01P 13/00; A01P 5/00; A01P 15/00

(52) U.S. Cl. CPC A01N 31/00; A01P 11/00; A01P 3/00; A01P 7/04; A01P 7/02; A01P 13/00; A01P 5/00; A01P 15/00

(57) ABSTRACT

Disclosed herein is a composition (C) including: (A) a solvent system; and (B) at least one biocide. The solvent system includes: (A1) a first component selected from an organic acid (A1a) or an alcohol (A1b); and (A2) a second component selected from an organic acid (A2a), an alcohol (A2b), an ester (A2c) or an ether (A2d), with the proviso that the Hansen solubility parameters of the first component (A1) are different from the Hansen solubility parameters of the second component (A2).

### FIELD OF THE INVENTION

The presently claimed invention is directed to a composition (C) comprising: (A) a solvent system; and (B) at least one biocide. The solvent system comprises: (A1) a first component selected from an organic acid (A1a) or an alcohol (A1b); and (A2) a second component selected from an organic acid (A2a), an alcohol (A2b), an ester (A2c) or an ether (A2d), with the proviso that the Hansen solubility parameters of the first component (A1) are different from the Hansen solubility parameters of the second component (A2).

### BACKGROUND OF THE INVENTION

Typically, biocides are formulated as aqueous solution or as emulsifiable concentrate. Prior to use, the emulsifiable concentrate is then emulsified with water. A problem often encountered when emulsifying the emulsifiable concentrate is the crystallization of the biocide(s) from the emulsion. Beside the loss active ingredient, crystallization of the biocide(s) also causes blocking of filter and/or nozzles when the emulsion is to be applied via spray equipment. As crystallization increases over time, it necessitates that the application of the emulsion takes place immediately or within a few hours after the emulsion is formed.

There have been numerous suggestions on how to solve this crystallization problem of the biocide(s). By example, in U.S. Pat. No. 5,206,225 A it is suggested to use certain alkylcarboxylic acid dimethylamides as crystallization inhibitors in spray solutions; U.S. Pat. No. 5,476,845 A discloses certain phosphoric esters as crystallization inhibitors; in U.S. Pat. Nos. 5,328,693 A and 5,369,118 A, certain long chain alkyl lactams are suggested as crystallization inhibitors; U.S. Pat. No. 5,053,421 A suggests di-styryl-phenyl-tri-glycol ether as crystallization inhibitor. There are several prior arts suggesting adding certain compounds as crystallization inhibitors.

Most biocides have very limited solubility in water or organic solvents; therefore, instead of emulsion concentrates, they have been formulated as suspension concentrates. Suspension concentrates also encounter similar problem such as crystallization of the biocide. The crystallization of the biocide(s) lead to the blocking of the filters and/or nozzles of the spray equipment during the application.

EP 933025 A1 discloses an emulsifiable concentrate formulation comprising a pesticide, a solvent system comprising esters of plant oils and a water-miscible polar aprotic cosolvent and an emulsifier system comprising a mixture of both anionic and non-ionic surfactants.

GB 2 091 558 A discloses that high amount of biocidel organotin compounds can be dissolved in water immiscible alcohol at 50° C. and aromatic hydrocarbon solvent to give solutions which remain stable upon cooling.

EP 0095242 discloses a liquid composition of fungicides in alkylated benzene sulfonic acids. However, the solubility of the biocides is very low as 2 to 10 w. %.

WO 2010/052178 A1 discloses another solvent system based on cyclohexanone or acetophenone. However, the solubility of the biocides in these solvent systems are either less or around 10 wt. %.

Despite the progress disclosed in the prior art there is still a need for improved emulsifiable concentrate formulations giving rise to a low degree of crystal formation or completely eliminate the crystallization in the emulsifiable concentrates or diluted ready to use emulsions. In addition, it would be desirable to replace the aromatic hydrocarbon solvent from the emulsifiable concentrate with more environment friendly solvents. Yet another objective of the presently claimed invention is to replace the suspension concentrates with an emulsifiable concentrate, as suspension concentrate pose many potential problems for producers such as need to mill the biocides into fine powder and for farmers such as higher cost, equipment clogging and limited suspension stability. Still another object of the presently claimed invention is to provide a solvent system which can dissolve higher amount of biocide, preferably at least 5 wt. %, more preferably at least 20 wt. % based on overall weight of biocide and solvent system. Another object is to provide a solvent system which is devoid of environmental hazardous aromatic hydrocarbon.

### SUMMARY OF THE INVENTION

Surprisingly, it has been found that biocides can be solubilized in a solvent system comprising (A1) a first component selected from an organic acid (a1e) or an alcohol (a1b); and (A2) a second component selected from an organic acid (a2a), an alcohol (a2b), an ester (a2c) or an ether (a2d), with the proviso that the Hansen solubility parameters of the first component (A1) are different from the Hansen solubility parameters of the second component (A2). Such compositions can be formulated as an emulsifiable solutions which eliminates or reduces the problem associated with the low solubility of the biocides and all other disadvantages of the solid concentrates. Without being bound to this theory, when the first component (A1) and the second component (A2) are combined in a specific molar ratio they form a solution, which can dissolve the biocides. The so obtained solution can easily be emulsified and forms a stable emulsion when emulsified in water. Surprisingly, it has been found that such solutions eliminate or reduces the problem of crystallization of the biocides from the emulsifiable solutions and from the final ready to use emulsion.

Accordingly, the first aspect of the presently claimed invention is directed to a composition (C) comprising:
(A) a solvent system in an amount of 15.0 to 95.0% by weight, based on the overall weight of the composition; and
(B) at least one biocide in an amount of 5.0 to 60.0% by weight, based on the overall weight of the composition;
wherein the total amount of the solvent system (A) and the at least one biocide (B) is in the range of 20.0 to 100% by weight based on the overall weight of the composition, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2).

The second aspect of the presently claimed invention is directed to the use of a solvent system for preparing an emulsifiable concentrate comprising at least one biocide, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of the first component (A1) are different from the Hansen solubility parameters of the second component (A2).

The third aspect of the presently claimed invention is directed to a method of preparing a composition (C) comprising the steps of:
i. providing a solvent system; and
ii. adding at least one biocide to the solvent system of step i. to obtain a mixture; wherein the solvent system comprises:
(A1) a first component selected from an organic acid (A1a) or an alcohol (A1b); and
(A2) a second component selected from an organic acid (A2a), an alcohol (A2b), an ester (A2c), or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of component (A1) are different from the Hansen solubility parameters of component (A2).

The fourth aspect of the presently claimed invention is directed to an emulsion composition (E) comprising:
a composition (C) in an amount in the range of 0.1 to 20.0% by weight, based on the overall weight of the emulsion composition (E); and
water in an amount in the range of 60.0 to 99.9% by weight based on the overall weight of the composition (E);
wherein the total amount of the composition (C) and water is in the range of 61.1 to 100% by weight based on the overall weight of the emulsion composition (E).

The fifth aspect of the presently claimed invention is directed to the use of the emulsion composition (E) for the treatment of soil and plants.

The sixth aspect of the presently claimed invention is directed to a method of treating soil and plants comprising the step of applying the emulsion composition (E) to the soil or plants.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or a, b, c, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Within the context of the presently claimed invention, the Hansen solubility parameters for the solvents has been calculated at 25° C. and at atmospheric pressure unless otherwise specified. Hansen Solubility Parameters: a user's handbook by Charles M Hansen is a standard reference guide.

Within the context of the presently claimed invention, if a solvent has two functional groups the compound is grouped into a solvent based on the priority of the functional group as per IUPAC nomenclature. For example, monoalkyl esters of a diacid is grouped as acid solvent system for the presently claimed invention.

In a first embodiment, the presently claimed invention is directed to a composition (C) comprising:
(A) a solvent system in an amount of 15.0 to 95.0% by weight, based on the overall weight of the composition; and
(B) at least one biocide in an amount of 5.0 to 60.0% by weight, based on the overall weight of the composition;
wherein the total amount of the solvent system (A) and the at least one biocide (B) is in the range of 20.0 to 100% by weight based on the overall weight of the composition, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); preferably the composition (C) comprises:
(A) a solvent system in an amount of 25.0 to 85.0% by weight, based on the overall weight of the composition; and
(B) at least one biocide in an amount of 10.0 to 50.0% by weight, based on the overall weight of the composition;
wherein the total amount of the solvent system (A) and the at least one biocide (B) is in the range of 35.0 to 100% by weight based on the overall weight of the composition,
wherein the solvent system comprises:

(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); more preferably the composition (C) comprises:
(A) a solvent system in an amount of 40.0 to 85.0% by weight, based on the overall weight of the composition; and
(B) at least one biocide in an amount of 15.0 to 50.0% by weight, based on the overall weight of;
wherein the total amount of the solvent system (A) and the at least one biocide (B) is in the range of 55.0 to 100% by weight based on the overall weight of the composition,
wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); most preferably the composition (C) comprises:
(A) a solvent system in an amount of 40.0 to 80.0% by weight, based on the overall weight of the composition; and
(B) at least one biocide in an amount of 15.0 to 50.0% by weight, based on the overall weight of the composition;
wherein the total amount of the solvent system (A) and the at least one biocide (B) is in the range of 55.0 to 100% by weight based on the overall weight of the composition, wherein the solvent system comprises:
(A1) a first component selected from an organic acid (A1a) or an alcohol (A1b); and (A2) a second component selected from an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2}, wherein the mole ratio of the first component to the second component is in the range of 1.0:3.0 to 3.0:1.0; and
with the proviso that the Hansen solubility parameters of the first component (A1) are different from the Hansen solubility parameters of the second component (A2); and in particular preferably the composition (C) comprises:
(A) a solvent system in an amount of 50.0 to 80.0% by weight, based on the overall weight of the composition; and
(B) at least one biocide in an amount of 20.0 to 50.0% by weight, based on the overall weight of the composition;
wherein the total amount of the solvent system (A) and at least one biocide (B) is in the range of 70.0 to 100% by weight based on the overall weight of the composition,
wherein the solvent system comprises:
(A1) a first component selected from an organic acid (A1a) or an alcohol (A1b); and
(A2) a second component selected from an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:3.0 to 3.0:1.0; and
with the proviso that the Hansen solubility parameters of the first component (A1) are different from the Hansen solubility parameters of the second component (A2).

In another preferred embodiment, the presently claimed invention is directed to a composition (C) comprising:
(A) a solvent system in an amount of 15.0 to 95.0% by weight, based on the overall weight of the composition;
(B) at least one biocide in an amount of 5.0 to 60.0% by weight, based on the overall weight of the composition; and
(D) at least one emulsifier (D) in an amount of 1.0 to 50.0% by weight, based on the overall weight of the composition (C)
wherein the total amount of the solvent system (A), the at least one biocide (B) and the at least one emulsifier (D) is in the range of 21.0 to 100% by weight based on the overall weight of the composition,
wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); more preferably the composition (C) comprises:
(A) a solvent system in an amount of 25.0 to 85.0% by weight, based on the overall weight of the composition;
(B) at least one biocide in an amount of 10.0 to 50.0% by weight, based on the overall weight of the composition; and
(D) at least one emulsifier (D) in an amount of 1.0 to 40.0% by weight, based on the overall weight of the composition (C)
wherein the total amount of the solvent system (A), the at least one biocide (B) and the at least one emulsifier (D) is in the range of 36.0 to 100% by weight based on the overall weight of the composition,
wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); even more preferably the composition (C) comprises:
(A) a solvent system in an amount of 40.0 to 85.0% by weight, based on the overall weight of the composition;
(B) at least one biocide in an amount of 15.0 to 50.0% by weight, based on the overall weight of the composition; and
(D) at least one emulsifier (D) in an amount of 5.0 to 30.0% by weight, based on the overall weight of the composition (C)
wherein the total amount of the solvent system (A), the at least one biocide (B) and the at least one emulsifier (D) is in the range of 55.0 to 100% by weight based on the overall weight of the composition,
wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2); most preferably the composition (C) comprises:
(A) a solvent system in an amount of 40.0 to 80.0% by weight, based on the overall weight of the composition;
(B) at least one biocide in an amount of 15.0 to 50.0% by weight, based on the overall weight of the composition; and
(D) at least one emulsifier (D) in an amount of 10.0 to 30.0% by weight, based on the overall weight of the composition (C)
wherein the total amount of the solvent system (A), the at least one biocide (B) and the at least one emulsifier (D) is in the range of 65.0 to 100% by weight based on the overall weight of the composition,
wherein the solvent system comprises:
(A1) a first component selected from an organic acid (A1a) or an alcohol (A1b); and (A2) a second component selected from an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:3.0 to 3.0:1.0; and
with the proviso that the Hansen solubility parameters of the first component (A1) are different from the Hansen solubility parameters of the second component (A2); and in particular preferably the composition (C) comprises:
(A) a solvent system in an amount of 50.0 to 75.0% by weight, based on the overall weight of the composition;
(B) at least one biocide in an amount of 20.0 to 50.0% by weight, based on the overall weight of the composition; and
(D) at least one emulsifier (D) in an amount of 5.0 to 20.0% by weight, based on the overall weight of the composition (C)
wherein the total amount of the solvent system (A), the at least one biocide (B) and the at least one emulsifier (D) is in the range of 80.0 to 100% by weight based on the overall weight of the composition,
wherein the solvent system comprises:
(A1) a first component selected from an organic acid (A1a) or an alcohol (A1b); and (A2) a second component selected from an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:3.0 to 3.0:1.0; and
with the proviso that the Hansen solubility parameters of the first component (A1) are different from the Hansen solubility parameters of the second component (A2).

In an embodiment, the total amount of the first component (A1) and the second component (A2) is in the range of 60.0 to 100% by weight based on the overall weight of the solvent system; more preferably the total amount of the first component (A1) and the second component (A2) is in the range of 60.0 to 90.0% by weight based on the overall weight of the solvent system; and most preferably the total amount of the first component (A1) and the second component (A2) is in the range of 60.0 to 75.0% by weight based on the overall weight of the solvent system.

In another preferred embodiment, the biocide is selected from fungicide, insecticide, acaricide, rodenticide, nematicide, herbicide, or miticide.

In another preferred embodiment, the fungicide is selected from bitertanol, bromuconazole, cyproconazole, diclobutrazole, diniconazole, epoxiconazole, etaconazole, fenbuconazole, fluquinconazole, flusilazole, flutriafol, hexaco nazole, myclobutanil, penconazole, propiconazole, prothioconazole, tebuconazole, tetraconazole, triadimefon, triadimenol, triticonazole,2-aminobutane, 8-hydroxyquinoline sulphate, 2-phenylphenol (OPP), aldi-morph, ampropylfos, anilazine, azoxystrobin, benalaxyl, benodanil, benomyl, binapacryl, biphenyl, blasticidin-S, bupirimate, buthiobate, calcium polysulphide, captafol, captan, carbendazim, carboxin, carpropamid, quinomethionate, chloroneb, chloropicrin, chlorothalonil, chlozolinate, cufraneb, cyazofamid, cymoxanil, cyprodinil, cyprofuram, dichlorophen, diclocymet, diclofluanid, diclomezin, dicloran, diethofencarb, diflumetorim, dimethirimol, dimethomorph, dinocap, diphenylamine, dipyrithion, ditalimfos, dithianon, dodine, drazoxolon, edifenphos, enestroburin, ethaboxam, ethirimol, etridiazole, famoxadone, fenamidone, fenarimol, fenfuram, fenhexamid, fenitropan, fenpiclonil, fenpropidin, fenpropimorph, fentin acetate, fentin hydroxide, ferbam, ferimzone, fluazinam, fludioxonil, flumorph, fluoromide, fluoxastrobin, flusulfamide, flutolanil, folpet, fosetyl-aluminium, fthalide, fuberidazole, furalaxyl, furmecyclox, guazatine, hexachlorobenzene, imazalil, iminoctadine, iprobenfos (IBP), iprodione, iprovalicarb, isoprothiolane, kasugamycin, copper preparations such as: copper hydroxide, copper naphthenate, copperoxychloride, copper sulphate, copper oxide, oxine-copper and Bordeaux mixture, mancopper, mancozeb, maneb, mepanipyrim, kresoxim-methyl, mepronil, metalaxyl, methasulfocarb, methfuroxam, metiram, metominostrobin, metrafenone, metsulfovax, myclobutanil, nickel dimethyldithiocarbamate, nitrothal-isopropyl, nuarimol, ofurace, oxadixyl, oxamocarb, oxycarboxin, pefurazoate, pencyuron, phosdiphen, picoxystrobin, pimaricin, piperalin, polyoxin, probenazole, prochloraz, procymidone, propamocarb, propineb, pyraclostrobin, pyrazophos, pyrifenox, pyrimethanil, pyroquilon, quinoxyfen, quintozene (PCNB), silthiofam, spiroxamine, sulphur and sulphur preparations, tecloftalam, tecnazene, thiabendazole, thicyofen, thifluzamide, thiophanate-methyl, thiram, tolclophos-methyl, tolylfluanid, triazoxide, trichlamide, tricyclazole, tridemorph, trifloxystrobin, triflumizole, triforine, validamycin, vinclozolin, zineb, ziram, or zoxamide.

In another preferred embodiment, the insecticide is selected from fenoxycarb, piperonyl butoxide, imidacloprid, thiacloprid, acetamiprid, aldicarb sulfone, pirimicarb, chlorantraniliprole, terbufos, quinalphos, dyfonate, phosmet, carbaryl, etoxazole, thiamethoxam, flonicamid, etofenprox, phorate, profenofos, parathion, methylparathion, axephate, disulfoton, fenthion, fipronil, baygon, methomyl, pymetrozine, oxamyl, fau-fluvalinate, cypermethrin, cyfluthrin, bifenthrin, tetramethrin, prallethrin (mix of isomers), permethrin (mix of isomers), resmethrin (mix of isomers), pyrethrin (mix of isomers), spinetoram(J), abamectin (mix of isomers), fenobucarb (BPMC), methiocarb, isoprocarb (MIPC), spirotetramat, Spinosad, trichlorfon, fenamiphos sulfoxide, fenamiphos sulfone, 3-hydroxycarbofuran, aldrin, DDE (p-p′), DDD (o-p), DDD (p-p′), DDE (o-p), DDT (o-p′), dieldrin, endrin, endrin aldehyde, endrin ketone, isodrin, chlordecone, or mirex.

In another preferred embodiment, the acaricide is selected from tebufenpyrad, aldicard, azinphosmethyl, carbophenothion, dimethoate, dicrotophos, triazophos, malathion, phosalone, methidathion, hexythiazox, propargite, spirodiclofen, methamidophos, monocrotophos, phenthoate, pirimiphosmethyl, epn, dichlorvos, ethion, fenitrothion, diazinon, chlorpyriphos, oxydemeton methyl, pyridaben, fenpropathrin, bifenazate, spiromesifen, fenpyroximate (mix of isomers), acequinocyl, or carbofuran.

In another preferred embodiment, the rodenticide is coumaphos.

In another preferred embodiment, the nematicide is ethoprophos.

In another preferred embodiment, the herbicide is selected from paclobutrazol, diuron, linuron, isoproturon, alachlor, pendimethalin, chlorpropham, fenoprop, bentazone, metolachlor, propazine, bromacil, 2,4-DB, fenoxaprop, fluometuron, molinate, cyanazine, simazine, atrazine, atrazine desmethyl, or metribuzin.

In another preferred embodiment, the miticide is clofentezine.

In an embodiment, the biocides are selected from trifloxystrobin, boscalid, fenoxycarb, piperonyl butoxide, tebufenpyrad, iprodione, imidacloprid, imazalil, aldicarb, aldicarb sulfoxide, thiacloprid, azoxystrobin, acetamiprid, aldicarb sulfone, pirimicarb, chlorantraniliprole, azinphos-methyl, carbophenothion, coumaphos, ethoprophos, dimethoate, dicrotophosterbufos, quinalphos, triazophos, dyfonate, malathion, phosmet, phosalone, methidathion, hexythiazox, propargite, carbaryl, myclobutanil, dimethomorph, etoxazole, spirodiclofen, thiamethoxam, flonicamid, etofenprox, phorate, methamidophos, profenofos, monocrotophos, phenthoate, pirimiphosmethyl, epn, dichlorvos, edifenphos, ethion, fenitrothion, parathion, methyl parathion, acephate, disulfoton, fenthion, diazinon, chlorpyriphos, fipronil, fludioxonil, chlorothalonil, baygon, metalaxyl, methomyl, pymetrozine, pyraclostrobin, oxamyl, paclobutrazol, prochloraz, clofentezine, diuron, linuron, isoproturon, pencycuron, oxydemetonmethyl, fenvalerete, pyridaben, tau-fluvalinate, quinoxyfen, alachlor, pendimethalin, kresoximmethyl, chlorpropham, epoxiconazole, fenpropathrin, fenoprop, bentazone, metolachlor, quintozene, captan, cypermethrin, cyfluthrin, bifenthrin, tetramethrin, prallethrin (mix of isomers), permethrin (mix of isomers), resmethrin (mix of isomers), pyrethrin (mix of isomers), hexaconazole, propiconazole, bifenazate, spiromesifen, spinetoram (J), abamectin (mix of isomers), fenobucarb (BPMC), methiocarb, propazine, isoprocarb (MIPC), spirotetramat, fenpyroximate (mix of isomers), spinosad (as Spinosyn A), bromacil, 2,4-DB, fenoxaprop, fluometuron, fenhexamid, trichlorfon, fenamiphossulfoxide, fenamiphossulfone, molinate, 3-hydroxycarbofuran, thiophanatemethyl, acequinocyl, carbofuran, cyanazine, simazine, atrazine, atrazinedesethyl, Aldrin, DDE (p-p′), DDD (o-p), DDD (p-p′), DDE (o-p), DDT (o-p′), DDT (p-p′), dieldrin, endrin, endrin aldehyde, endrin ketone, isodrin, chlordecone, metribuzin, or mirex.

In another preferred embodiment, the organic acids (A1a) and (A2a) are selected from formic acid, substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids; more preferably the organic acids (A1a) and (A2a) are selected from formic acid, substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₆-C₂₄ aryl carboxylic acids, or substituted or unsubstituted C₇-C₂₄ arylalkyl carboxylic acids; most preferably the organic acids (A1a) and (A2a) are selected from formic acid, substituted or unsubstituted, linear or branched C₁-C₂₄ alkyl carboxylic acids, substituted or unsubstituted, linear or branched C₂-C₁₄ alkenyl carboxylic acids, substituted or unsubstituted C₅-C₂₄ cycloalkyl carboxylic acids, or substituted or unsubstituted C₇-C₂₄ arylalkyl carboxylic acids; and in particular preferably the organic acids (A1a) and (A2a) are selected from formic acid, substituted or unsubstituted, linear or branched C₁-C₂₄ alkyl carboxylic acids, substituted or unsubstituted C₅-C₂₄ cycloalkyl carboxylic acids, or unsubstituted C₇-C₂₄ arylalkyl carboxylic acids.

In another preferred embodiment, the substituted or unsubstituted, linear or branched C₁-C₂₄ alkyl carboxylic acids are mono carboxylic acid, or dicarboxylic acid or polycarboxylic acid.

In another preferred embodiment, the substituted or unsubstituted, linear or branched C₁-C₂₄ alkyl carboxylic acids are selected from CH₃COOH, CH₃CH₂COOH, CH₃(CH₂)₂COOH, CH₃(CH₂)₃COOH, CH₃(CH₂)₄COOH, CH₃(CH₂)₅COOH, CH₃(CH₂)₆COOH, CH₃(CH₂)₇COOH, CH₃(CH₂)₈COOH, CH₃(CH₂)₉COOH, CH₃(CH₂)₁₀COOH, CH₃(CH₂)₁₁COOH, CH₃(CH₂)₁₂COOH, CH₃(CH₂)₁₃COOH, CH₃(CH₂)₁₄COOH, CH₃(CH₂)₁₅COOH, CH₃(CH₂)₁₆COOH, CH₃(CH₂)₁₇COOH, CH₃(CH₂)₁₈COOH, CH₃(CH₂)₁₆COOH, CH₃(CH₂)₂₀COOH, CH₃(CH₂)₂₁COOH, CH₃(CH₂)₂₂COOH, HOCH₂COOH, CH₃CH(OH)COOH, HOOCCOOH, CH₂(OH)CH₂COOH, CH₂(OH)C(CH₃)₂COOH, CH₂(OH)CH(OH)COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, CH₃COCH₂COOH, HOOC(CH₂)₂COOH, HOOCCH(CH₃)COOH, HOOCCH₂CH(OH)COOH, HOOC(CHOH)₂COOH, HOOCCH₂COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₈COOH; more preferably the substituted or unsubstituted, linear or branched C₁-C₂₄ alkyl carboxylic acids are selected from CH₃COOH, CH₃CH₂COOH, CH₃(CH₂)₂COOH, CH₃(CH₂)₃COOH, CH₃(CH₂)₄COOH, CH₃(CH₂)₅COOH, CH₃(CH₂)₆COOH, CH₃(CH₂)₁₀COOH, CH₃(CH₂)₁₂COOH, CH₃(CH₂)₁₄COOH, CH₃(CH₂)₁₆COOH, HOCH₂COOH, CH₃CH(OH)COOH, CH₂(OH)CH₂COOH, CH₂(OH)C(CH₃)₂COOH, CH₂(OH)CH(OH)COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, HOOC(CH₂)₂COOH, HOOCCH(CH₃)COOH, HOOCCH₂CH(OH)COOH, HOOC(CHOH)₂COOH, HOOCCH₂COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₈COOH; most preferably the substituted or unsubstituted, linear or branched C₁-C₂₄ alkyl carboxylic acids are selected from CH₃COOH, CH₃CH₂COOH, CH₃(CH₂)₁₀COOH, CH₃(CH₂)₁₂COOH, CH₃(CH₂)₁₄COOH, CH₃(CH₂)₁₈COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, 1.0 CH₂(OH)C(CH₃)₂COOH, HOOC(CH₂)₂COOH, HOOCCH(CH₃)COOH, HOOCCH₂CH(OH)COOH, HOOC(CHOH)₂COOH, HOOCCH₂COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₈COOH; and in particular preferably the substituted or unsubstituted, linear or branched C₁-C₂₄ alkyl carboxylic acids are selected from CH₃COOH, CH₂(OH)C(CH₃)₂COOH, HOOC(CH₂)₂COOH, HOOCCH(CH₃)COOH, HOOCCH₂CH(OH)COOH, (CH₃)₂CHCH₂COOH, (CH₃)₃CCOOH, CH₃CH₂CH(OH)CH₂COOH, (CH₃)₂C(OH)CH₂COOH, HOOC(CH₂)₃COOH, HOOC(CH₂)₄COOH, (HO)C(COOH)((CH₂)COOH)₂, or HOOCCH(OH)CH(COOH)CH₂COOH.

In another preferred embodiment, the substituted or unsubstituted, linear or branched alkenyl carboxylic acids are selected from propenoic acid, crotonic acid, isocrotonic acid, methacrylic acid, vinyl acetic acid, fumaric acid, maleic acid, prop-1-ene-1,2,3-tricarboxylic acid, (2E,4E)-hexa-2,4-dienoic acid, cinnamic acid, myristoleic acid, palmitoleic acid, sapienic acid; more preferably the substituted or unsubstituted, linear or branched alkenyl carboxylic acids are selected from propenoic acid, vinyl acetic acid, fumaric acid, maleic acid, prop-1-ene-1,2,3-tricarboxylic acid, (2E,4E)-hexa-2,4-dienoic acid, and cinnamic acid; and most preferably the substituted or unsubstituted, linear or branched alkenyl carboxylic acids are selected from vinyl acetic acid, fumaric acid, maleic acid, and cinnamic acid.

In another preferred embodiment, the substituted or unsubstituted C₅-C₂₄ cycloalkyl carboxylic acids are selected from cyclopentane carboxylic acid, 1,2-cyclopentane dicarboxylic acid, cyclohexane carboxylic acid, 3-methyl cyclohexane carboxylic acid, 4-methyl cyclohexane carboxylic acid, 1,4-cyclohexane dicarboxylic acid, or 4-hydroxy cyclohexane carboxylic acid.

In an embodiment, the substituted or unsubstituted C₆-C₂₄ aryl carboxylic acids selected from 3-hydroxy benzoic acid, 4-hydroxy benzoic acid, 2,3-dihydroxy benzoic acid, 2,4-dihydroxy benzoic acid, 2,4-dihydroxy benzoic acid, 2,6-dihydroxy benzoic acid, 3,4-dihydroxy benzoic acid, 3,5-dihydroxy benzoic acid, 3,6-dihydroxy benzoic acid, phthalic acid, gallic acid, toluic acid, isophthalic acid, terephthalic acid, salicylic acid, acetyl salicylic acid, 3-methoxy benzoic acid or 4-methoxy benzoic acid.

In another preferred embodiment, the substituted or unsubstituted C₇-C₂₄ arylalkyl carboxylic acids selected from phenyl acetic acid, 2-phenyl propanoic acid, 2-hydroxy phenyl acetic acid, 3-hydroxy phenyl acetic acid, 4-hydroxy phenyl acetic acid, 3-chloro-4-hydroxyphenyl acetic acid, indole-3-acetic acid, 3,5-dimethoxy-4-hydroxyphenyl acetic acid, α-hydroxyphenyl acetic acid or 3-ethoxy-4-hydroxyphenyl acetic acid; more preferably the substituted or unsubstituted C₇-C₂₄ arylalkyl carboxylic acids selected from phenyl acetic acid, 2-phenyl propanoic acid, 4-hydroxy phenyl acetic acid, indole-3-acetic acid, or α-hydroxyphenyl acetic acid; most preferably the substituted or unsubstituted C₇-C₂₄ arylalkyl carboxylic acids selected from phenyl acetic acid, 4-hydroxy phenyl acetic acid, indole-3-acetic acid, or α-hydroxyphenyl acetic acid; and in particular preferably the substituted or unsubstituted C₇-C₂₄ arylalkyl carboxylic acids selected from phenyl acetic acid or 4-hydroxy phenyl acetic acid.

In another preferred embodiment, the organic acids (A1a) and (A2a) are selected from acetic acid, formic acid, D,L-lactic acid, nonanoic acid, dodecanoic acid, hydroxy pivalic acid, or phenyl acetic acid.

In an embodiment, the organic alcohols (A1b) and (A2b) are selected from substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols (phenol), or substituted C₇-C₂₄ arylalkyl alcohols; and more preferably organic alcohols (A1b) and (A2b) are selected from substituted or unsubstituted, linear or branched C₄-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₆-C₂₄ aryl alcohols, or substituted C₇-C₂₄ arylalkyl alcohols.

In another preferred embodiment, the organic alcohols (A1b) and (A2b) are selected from allyl alcohol, 1,3-benzenediol, 2-bromoallyl alcohol, 2,3-butadiene-1-ol, 1,3-butanedol, 1,4-butanediol, t-butyl alcohol, butoxyethoxy propanol, 3-butoxy butanol, 3-chloroallyl alcohol, 2-chloroallyl alcohol, 3-chloro-1-propanol, 4-chlorobenzyl alcohol, 2-chlorophenol, m-cresol, cyclohexanol, 2-cyclopentenyl alcohol, 1-decanol, 2-decanol, diacetone alcohol, 2-(deithyamino)ethanol, diethylene glycol, diisobutyl carbinol, 2,6-dimethyl phenol, 3,4-dimethyl phenol, dipropylene glycol, ethanol, ethanolamine, 1-ethoxy ethoxy-2-propanol, 2-ethyl-1-butanol, 2-ethylhexanol, ethylene glycol, glycerol, hexylene glycol, 3-methyl-1-butanol, isobutyl alcohol, isooctyl alcohol, methanol, menthol, carvacrol, 2-ethyl phenol, o-methoxy, phenol, 3-methyl allyl alcohol, methyl isobutyl carbinol, 2-methyl-1-butanol, 2-methyl-1-propanol, 2-methyl-2-butanol, 1-octanol, 2-octanol, 1-pentanol, 2-pentanol, phenol, 2-phenoxy ethanol, 1-propanol, 2-propanol, propylene glycol, triethanolamine, triethylene glycol, triethylene glycol monomethylether, 4-methyl cyclohexanol, 2-phenylethanol, thymol, 4-isopropylbenzylmethanol, 2-phenoxyethanol, or 2-methoxyphenol; more preferably the organic alcohols (A1b) and (A2b) are selected from menthol, carvacrol, 2-ethyl phenol, 1,3-benzenediol, t-butyl alcohol, butoxyethoxy propanol, 3-butoxy butanol, 4-chlorobenzyl alcohol, 2-chlorophenol, m-cresol, cyclohexanol, 2-cyclopentenyl alcohol, 1-decanol, 2-decanol, 2-(diethylamino)ethanol, diethylene glycol, diisobutyl carbinol, 2,6-dimethyl phenol, 3,4-dimethyl phenol, dipropylene glycol, ethanolamine, 2-ethylhexanol, ethylene glycol, glycerol, hexylene glycol, 3-methyl-1-butanol, isobutyl alcohol, isooctyl alcohol, o-methoxyphenol, methyl isobutyl carbinol, 2-methyl-1-butanol, 2-methyl-1-propanol, 2-methyl-2-butanol, 1-octanol, 2-octanol, 1-pentanol, 2-pentanol, phenol, 2-phenoxy ethanol, 1-propanol, 2-propanol, propylene glycol, triethanolamine, triethylene glycol, triethylene glycol monomethylether, 4-methyl cyclohexanol, 2-phenylethanol, thymol, 4-isopropylbenzylmethanol, 2-phenoxyethanol, or 2-methoxyphenol; even more preferably the organic alcohols (A1b) and (A2b) are selected from menthol, carvacrol, 2-ethyl phenol, t-butyl alcohol, m-cresol, cyclohexanol, 2-cyclopentenyl alcohol, 2-(deithylamino)ethanol, diethylene glycol, diisobutyl carbinol, 2,6-dimethyl phenol, 3,4-dimethyl phenol, dipropylene glycol, ethanolamine, 2-ethylhexanol, ethylene glycol, glycerol, isooctyl alcohol, o-methoxyphenol, methyl isobutyl carbinol, phenol, 2-phenoxy ethanol, 1-propanol, 2-propanol, propylene glycol, triethanolamine, triethylene glycol, triethylene glycol monomethylether, 4-methyl cyclohexanol, 2-phenylethanol, thymol, 4-isopropylbenzylmethanol, 2-phenoxyethanol, or 2-methoxyphenol; most preferably the organic alcohols (A1b) and (A2b) are selected from menthol, carvacrol, 2-ethyl phenol, m-cresol, cyclohexanol, 2-(deithyamino)ethanol, diethylene glycol, ethanolamine, 2-ethylhexanol, ethylene glycol, glycerol, o-methoxyphenol, phenol, 2-phenoxy ethanol, 1-propanol, 2-propanol, propylene glycol, triethanolamine, triethylene glycol, triethylene glycol monomethylether, 4-methyl cyclohexanol, 2-phenylethanol, thymol, 4-isopropylbenzylmethanol, or 2-phenoxyethanol, 2-methoxyphenol; and in particular preferably the organic alcohols (A1b) and (A2b) are selected menthol, carvacrol, 2-ethylphenol, 4-methyl cyclohexanol, 2-phenylethanol, thymol, 4-isopropylbenzylmethanol, 2-phenoxyethanol, or 2-methoxyphenol.

In an embodiment, the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl or aryl esters of substituted or unsubstituted C₇-C₂₄ arylalkyl carboxylic acid.

In another preferred embodiment, the organic ester (A2c) is selected from butyl lactate, n-butyl salicylate, ethyl lactate, methyl formate, methyl salicylate, allyl acetate, allyl acetoacetate, allyl formate, amyl acetate, benzyl butyl phthalate, benzyl methacrylate, n-butyl acetate, sec-butyl acetate, n-butyl acetoacetate, dibutyl fumarate, dibutyl phthalate, dibutyl sebacate, dibutyl stearate, diethyl phthalate, dimethyl phthalate, dioctyl phthalate, ethyl cinnamate, ethyl formate, glycidyl methacrylate, isoamyl acetate or methyl benzoate; more preferably the organic ester (A2c) is selected from butyl lactate, n-butyl salicylate, ethyl lactate, methyl formate, methyl salicylate, amyl acetate, benzyl butyl phthalate, benzyl methacrylate, n-butyl acetate, sec-butyl acetate, n-butyl acetoacetate, dibutyl fumarate, dibutyl phthalate, dibutyl sebacate, dibutyl stearate, diethyl phthalate, dimethyl phthalate, dioctyl phthalate, ethyl cinnamate, ethyl formate, glycidyl methacrylate, isoamyl acetate or methyl benzoate; even more preferably the organic ester (A2c) is selected from butyl lactate, n-butyl salicylate, ethyl lactate, methyl salicylate, amyl acetate, dibutyl fumarate, dibutyl sebacate, dibutyl stearate, diethyl phthalate, dimethyl phthalate, dioctyl phthalate, ethyl cinnamate, isoamyl acetate or methyl benzoate; most preferably the organic ester (A2c) is selected from butyl lactate, n-butyl salicylate, ethyl lactate, methyl salicylate, ethyl cinnamate, isoamyl acetate or methyl benzoate; and in particular preferably the organic ester (A2c) is selected from butyl lactate, n-butyl salicylate, ethyl lactate, methyl salicylate, or methyl benzoate.

In an embodiment, the organic ether (A2d) has C₅-C₃₀ carbon atoms.

In another preferred embodiment, the organic ether (A2d) is selected from triethylene glycol monomethylether, p-methoxyaniline, diethylene glycol hexylether, diethylene glycol monobutyllether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; more preferably the organic ether (A2d) is selected from p-methoxyaniline, diethylene glycol monomethylether, 1,2-dimethoxy benzene, 4-methoxy acetophenone, butenyl methyl ether, butyl isopropenyl ether, di-n-butyl ether, diphenyl ether, di(2-methoxyethyl)ether, dibenzyl ether, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; most preferably the organic ether (A2d) is selected from p-methoxyaniline, di-n-butyl ether, diphenyl ether, di(2-methoxyethyl)ether, dibenzyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; and in particular preferably the organic ether (A2d) is selected from p-methoxyaniline, di-n-butyl ether, diphenyl ether, di(2-methoxyethyl)ether, anisole, 4-ethoxy acetophenone, 4-methoxy acetophenone, 4-methoxy benzonitrile, nonyl phenoxy ethanol, or bis-(m-phenoxyphenyl) ether.

The ability of a solvent to dissolve a given substance, e.g. a biocide, may conveniently be evaluated by parameter consideration according to the so-called “Hansen system”, which is described in “Hansen Solubility Parameters—A Users Handbook”, published by CRC Press (2000). According to the Hansen system, a solvent or mixture of solvents may be described by three solubility parameters δd (dispersion parameter), δp (polarity parameter) and δh (hydrogen bonding parameter).

In an embodiment, the organic acids (A1a) and (A2a) each have Hansen solubility parameters in the ranges δd 13-25 MPa^{1/2}, δp 3-15 MPa's and δh 10-30 MPa^{1/2}.

In another preferred embodiment, the organic alcohols (A1b) and (A2b) each have Hansen solubility parameters in the ranges δd 14-20 MPa^{1/2}, δp 4-12.5 MPa % and δh 10-30 MPa^{1/2}.

In another preferred embodiment, the organic ester (A2c) has Hansen solubility parameters in the ranges δd 13-19 MPa^{1/2}, δp 3-9 MPa^{1/2}, and δh 3.5-14 MPa^{1/2}.

In another preferred embodiment, the organic ether (A2d) has Hansen solubility parameters in the ranges δd 14-20 MPa^{1/2}, δp 3-12 MPa^{1/2}, and δh 3-15 MPa^{1/2}.

In another preferred embodiment, the composition (C) further comprises at least one emulsifier (D) in an amount of 1.0 to 50.0% by weight, based on the overall weight of the composition (C); more preferably the composition (C) further comprises at least one emulsifier (D) in an amount of 1.0 to 40.0% by weight, based on the overall weight of the composition (C); even more preferably the composition (C) further comprises at least one emulsifier (D) in an amount of 5.0 to 30.0% by weight, based on the overall weight of the composition (C); most preferably the composition (C) further comprises at least one emulsifier (D) in an amount of 10.0 to 30.0% by weight, based on the overall weight of the composition (C); and in particular the composition (C) further comprises at least one emulsifier (D) in an amount of 10.0 to 25.0% by weight, based on the overall weight of the composition (C).

In an embodiment, the emulsifier (D) is selected from an anionic emulsifier or a non-ionic emulsifier.

In another preferred embodiment, the anionic emulsifier may be any known in the art and typically includes alkali, alkaline earth or ammonium salts of fatty acids, such as potassium stearate, alkyl sulfates, alkyl ether sulfates, alkylsulfonates or iso-alkylsulfonates, alkylnaphthalenesulfonates, alkyl methyl ester sulfonates, acyl glutamates, alkylsulfosuccinates, sarcosinates such as sodium lauroyl sarcosinate or taurates, and combinations thereof.

In another preferred embodiment, the anionic emulsifier is a calcium dodecylbenzene sulfonate (DDBSA) such as Ninate 401 A, Agnique® ABS 60, and Agnique® ABS 70C.

In another preferred embodiment, the non-ionic emulsifier may be any known in the art and typically includes alkoxylated animal or vegetable fats and oils such as corn oil ethoxylates, soybean oil ethoxylates, castor oil ethoxylates, tallow fatty ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (e.g. sorbitan monooleate, and sorbitan tristearate), polyoxyethylene sorbitan fatty acid esters, alkyl polyglycosides, N-alkylgluconamides, alkylmethyl sulfoxides, alkyldimethylphosphine oxides such as tetradecyldimethylphosphine oxide, and combinations thereof.

In another preferred embodiment, presently claimed composition (C) optionally comprises auxiliaries (G) pH-adjusters, thickeners, antifreeze agents, preservatives, antifoaming and defoamer agents, spreading agents, stickers, UV-protectants, and stabilizers. Such auxiliaries are generally known within the art of formulation chemistry, and although a specific ingredient is classified as falling within one category, it may well serve the purpose of any of the others.

In another preferred embodiment, the thickeners and film-forming agents are selected from starches, gums, casein and gelatine, polyvinyl pyrrolidones, polyethylene and polypropylene glycols, polyacrylates, polyacrylamides, polyethyleneimines, polyvinyl alcohols, polyvinyl acetates, and methyl-, hydroxyethyl- and hydroxypropylcelluloses or derivatives thereof Examples of the antifreezing agent include ethylene glycol, diethylene glycol, propylene glycol and the like.

In another preferred embodiment, the preservatives are selected from methyl and propyl parahydroxybenzoate, 2-bromo-2-nitro-propane-1,3-diol, sodium benzoate, formaldehyde, glutaraldehyde, 0-phenylphenol, benzisothiazolinones, 5-chloro-2-methyl-4-isothiazolin-3-one, pentachlorophenol, 2-4-dichlorobenzylalcohol, sorbic acid or derivatives thereof.

In another preferred embodiment, the anti-foaming and defoamer agents are silicone-based compounds e.g. polyalkylsiloxanes.

In another preferred embodiment, the stabilizers selected from phthalate(s) such as diethylhexyl phthalate, ethylhexyl phthalate, dimethyl phthalate, diethyl phthalate, butylbenzyl phthalate, dibutyl phthalate, diisononyl phthalate, or dioctyl phthalate. Preferred are dimethyl phthalate, diethyl phthalate or diisononyl phthalate, and especially diethyl phthalate.

In another preferred embodiment, the composition (C) has a viscosity in the range of 1 cps to 200 cps at 25° C. at atmospheric pressure; more preferably the composition has a viscosity in the range of 1 cps to 150 cps at 25° C. at atmospheric pressure; even more preferably the composition has a viscosity in the range of 1 cps to 100 cps at 25° C. at atmospheric pressure; most preferably the composition has a viscosity in the range of 1 cps to 80 cps at 25° C. at atmospheric pressure; and in particular preferably the composition has a viscosity in the range of 1 cps to 50 cps at 25° C. at atmospheric pressure. The viscosity is measured according to the method CIPAC MT 192-Scope.

In another preferred embodiment, the presently claimed invention is directed to an emulsifiable biocidel composition which does not contain environmental hazardous aromatic hydrocarbon as solvent.

In another embodiment, the presently claimed invention is directed to a composition (C) comprising:
(A) a solvent system in an amount of in the range of 70.0% to 90.0% by weight, based on the overall weight of the composition; and
(B) azoxystrobin in an amount of 20.0 to 40.0% by weight, based on the overall weight of the composition;
wherein the solvent system comprises: (A1) cyclohexanol; and (A2) D,L-lactic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 80.0% by weight, based on the overall weight of the composition; and
(B) azoxystrobin in an amount of 20.0% by weight, based on the overall weight of the composition;
wherein the solvent system comprises:
(A1) cyclohexanol; and (A2) D,L-lactic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:2.0.

In another embodiment, the presently claimed invention is directed to a composition (C) comprising:
(A) a solvent system in an amount of 80.0% by weight, based on the overall weight of the composition; and
(B) azoxystrobin in an amount of 20.0% by weight, based on the overall weight of the composition;
wherein the solvent system comprises: (A1) cyclohexanol; and (A2) D,L-lactic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio (A1) to (A2) is 1.0:1.0.

In another embodiment, the presently claimed invention is directed to a composition (C) comprising:
(A) a solvent system in an amount of in the range of 70.0% to 90.0% by weight, based on the overall weight of the composition; and
(B) tebuconazole in an amount of 20.0 to 50.0% by weight, based on the overall weight of the composition;
wherein the solvent system comprises:
(A1) cyclohexanol; and (A2) D,L-lactic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 53.0% by weight, based on the overall weight of the composition; and
(B) tebuconazole in an amount of 47.0% by weight, based on the overall weight of the composition;
wherein the solvent system comprises:
(A1) cyclohexanol; and (A2) D,L-lactic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:1.0.

In another embodiment, the presently claimed invention is directed to a composition (C) comprising:
(A) a solvent system in an amount of in the range of 70.0% to 90.0% by weight, based on the overall weight of the composition; and
(B) tebuconazole in an amount of 20.0 to 60.0% by weight, based on the overall weight of the composition;
wherein the solvent system comprises:
(A1) cyclohexanol; and (A2) formic acid; wherein Hansen solubility parameters of the cyclohexanol is δd 17.4 MPa^{1/2}, δp 4.1 MPa^{1/2} and δh 13.5 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) cyclohexanol; and (A2) formic acid;
wherein Hansen solubility parameters of the cyclohexanol is δd 17.4 MPa^{1/2}, δp 4.1 MPa^{1/2} and δh 13.5 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 62.0% by weight, based on the overall weight of the composition; and
(B) tebuconazole in an amount of 38.0% by weight, based on the overall weight of the composition;
wherein the solvent system comprises:
(A1) cyclohexanol; and (A2) methyl salicylate;
wherein Hansen solubility parameters of the cyclohexanol is δd 17.4 MPa^{1/2}, δp 4.1 MPa^{1/2} and δh 13.5 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 1.0:2.0.

In another embodiment, the presently claimed invention is directed to a composition (C) comprising:
(A) a solvent system in an amount of 60.0 to 80.0% by weight, based on the overall weight of the composition; and
(B) azoxystrobin in an amount of 20.0 to 40.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 50.0 to 80.0% by weight, based on the overall weight of the composition; and
(B) tebuconazole in an amount of 20.0 to 50.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 73.0% by weight, based on the overall weight of the composition; and
(B) azoxystrobin in an amount of 27.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 1.0:1.0.

In another embodiment, the presently claimed invention is directed to a composition (C) comprising:
(A) a solvent system in an amount of 62.0% by weight, based on the overall weight of the composition; and
(B) tebuconazole in an amount of 38.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 1.0:1.0.

In another embodiment, the presently claimed invention is directed to a composition (C) comprising:
(A) a solvent system in an amount of 75.0% by weight, based on the overall weight of the composition; and
(B) azoxystrobin in an amount of 25.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 1.0:2.0.

In another embodiment, the presently claimed invention is directed to a composition (C) comprising:
(A) a solvent system in an amount of 65.0% by weight, based on the overall weight of the composition; and
(B) tebuconazole in an amount of 35.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 1.0:2.0.

In another embodiment, the presently claimed invention is directed to a composition (C) comprising:
(A) a solvent system in an amount of 73.0% by weight, based on the overall weight of the composition; and
(B) azoxystrobin in an amount of 27.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0 MPa^{1/2}, and δh 13.9 MPa^{1/2},
wherein the mole ratio of (A1) to (A2) is 2.0:1.0.

In another embodiment, the presently claimed invention is directed to a composition (C) comprising:
(A) a solvent system in an amount of 58.0% by weight, based on the overall weight of the composition; and
(B) tebuconazole in an amount of 42.0% by weight, based on the overall weight of the composition;
wherein the solvent system comprises:
(A1) 2-phenylethanol; and (A2) methyl salicylate;
wherein Hansen solubility parameters of the 2-phenylethanol is δd 19 MPa^{1/2}, δp 5.8 MPa^{1/2} and δh 12.8 MPa^{1/2} and Hansen solubility parameters of the methyl salicylate is δd 18.1 MPa^{1/2}, δp 8.0
MPa^{1/2}, and δh 13.9 MPa^{1/2},
wherein the mole ratio of (A1) to (A2) is 2.0:1.0.

In another embodiment, the presently claimed invention is directed to a composition (C) comprising:
(A) a solvent system in an amount of 70.0 to 85.0% by weight, based on the overall weight of the composition; and
(B) azoxystrobin in an amount of 15.0 to 30.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 50.0 to 80.0% by weight, based on the overall weight of the composition; and
(B) tebuconazole in an amount of 20.0 to 50.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 60.0% by weight, based on the overall weight of the composition; and
(B) tebuconazole in an amount of 40.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:1.0.

In another embodiment, the presently claimed invention is directed to a composition (C) comprising:
(A) a solvent system in an amount of 80.0% by weight, based on the overall weight of the composition; and
(B) azoxystrobin in an amount of 20.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 80.0% by weight, based on the overall weight of the composition; and
(B) tebuconazole in an amount of 40.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 80.0% by weight, based on the overall weight of the composition; and
(B) azoxystrobin in an amount of 20.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 75.0% by weight, based on the overall weight of the composition; and
(B) tebuconazole in an amount of 35.0% by weight, based on the overall weight of the composition;
wherein the solvent system comprises:
(A1) 2-phenylethanol; and (A2) formic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 20.0 to 30.0% by weight, based on the overall weight of the composition; and
(B) azoxystrobin in an amount of 70.0 to 30.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 50.0 to 80.0% by weight, based on the overall weight of the composition; and
(B) tebuconazole in an amount of 50.0 to 20.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 75.0% by weight, based on the overall weight of the composition; and
(B) azoxystrobin in an amount of 25.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:1.0.

In another embodiment, the presently claimed invention is directed to a composition (C) comprising:
(A) a solvent system in an amount of 62.0% by weight, based on the overall weight of the composition; and
(B) tebuconazole in an amount of 38.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:1.0.

In another embodiment, the presently claimed invention is directed to a composition (C) comprising:
(A) a solvent system in an amount of 60.0% by weight, based on the overall weight of the composition; and
(B) tebuconazole in an amount of 40.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:2.0.

In another embodiment, the presently claimed invention is directed to a composition (C) comprising:
(A) a solvent system in an amount of 78.0% by weight, based on the overall weight of the composition; and
(B) azoxystrobin in an amount of 22.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 2.0:1.0.

In another embodiment, the presently claimed invention is directed to a composition (C) comprising:
(A) a solvent system in an amount of 62.0% by weight, based on the overall weight of the composition; and
(B) tebuconazole in an amount of 38.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 2.0:1.0.

In another embodiment, the presently claimed invention is directed to a composition (C) comprising:
(A) a solvent system in an amount of 80.0% by weight, based on the overall weight of the composition; and
(B) sulfentrazone in an amount of 20.0% by weight, based on the overall weight of the composition;
wherein the solvent system comprises:
(A1) 2-phenylethanol; and (A2) D,L-lactic acid;
wherein Hansen solubility parameters of the 2-phenylethanol is δd 19 MPa^{1/2}, δp 5.8 MPa^{1/2} and δh 12.8 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 2.0:1.0.

In another embodiment, the presently claimed invention is directed to a composition (C) comprising:
(A) a solvent system in an amount of 50.0 to 80.0% by weight, based on the overall weight of the composition; and
(B) azoxystrobin in an amount of 20.0 to 50.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 40.0 to 80.0% by weight, based on the overall weight of the composition; and
(B) tebuconazole in an amount of 20.0 to 60.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 60.0% by weight, based on the overall weight of the composition; and
(B) azoxystrobin in an amount of 40.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 73.0% by weight, based on the overall weight of the composition; and
(B) azoxystrobin in an amount of 27.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 75.0% by weight, based on the overall weight of the composition; and
(B) sulfentrazone in an amount of 25.0% by weight, based on the overall weight of the composition;
wherein the solvent system comprises:
(A1) formic acid; and (A2) methyl salicylate;
wherein Hansen solubility parameters of the methyl salicylate is δd 18.1 MPa^{1/2}, δp 8.0 MPa^{1/2}, and δh 13.9 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 40.0 to 90.0% by weight, based on the overall weight of the composition; and
(B) azoxystrobin in an amount of 10.0 to 60.0% by weight, based on the overall weight of the composition;
wherein the solvent system comprises:
(A1) formic acid; and (A2) anisole;
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 40.0 to 90.0% by weight, based on the overall weight of the composition; and
(B) tebuconazole in an amount of 10.0 to 60.0% by weight, based on the overall weight of the composition;
wherein the solvent system comprises:
(A1) formic acid; and (A2) anisole;
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 60.0 to 90.0% by weight, based on the overall weight of the composition; and
(B) sulfentrazone in an amount of 10.0 to 40.0% by weight, based on the overall weight of the composition;
wherein the solvent system comprises:
(A1) formic acid; and (A2) anisole;
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 60.0 to 80.0% by weight, based on the overall weight of the composition; and
(B) mesotrione in an amount of 20.0 to 40.0% by weight, based on the overall weight of the composition;
wherein the solvent system comprises:
(A1) formic acid; and (A2) anisole;
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 2.0:1.0 to 1.0:2.0.

In another embodiment, the presently claimed invention is directed to a composition (C) comprising:
(A) a solvent system in an amount of 43.0% by weight, based on the overall weight of the composition; and
(B) azoxystrobin in an amount of 57.0% by weight, based on the overall weight of the composition;
wherein the solvent system comprises:
(A1) formic acid; and (A2) anisole;
wherein Hansen solubility parameters of the anisole is δd 17.8 MPa^{1/2}, δp 4.1 MPa^{1/2}, and δh 6.7 MPa % and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) formic acid; and (A2) anisole
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 75.0% by weight, based on the overall weight of the composition; and
(B) sulfentrazone in an amount of 25.0% by weight, based on the overall weight of the composition;
wherein the solvent system comprises:
(A1) formic acid; and (A2) anisole wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 75.0% by weight, based on the overall weight of the composition; and
(B) mesotrione in an amount of 25.0% by weight, based on the overall weight of the composition;
wherein the solvent system comprises:
(A1) formic acid; and (A2) anisole
wherein Hansen solubility parameters of the anisole is δd 17.8 MPa^{1/2}, δp 4.1 MPa^{1/2}, and δh 6.7 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 2.0:1.0.

In another embodiment, the presently claimed invention is directed to a composition (C) comprising:
(A) a solvent system in an amount of 50.0 to 80.0% by weight, based on the overall weight of the composition; and
(B) azoxystrobin in an amount of 20.0 to 50.0% by weight, based on the overall weight of the composition;
wherein the solvent system comprises:
(A1) 2-phenoxyethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 50.0 to 80.0% by weight, based on the overall weight of the composition; and
(B) tebuconazole in an amount of 20.0 to 50.0% by weight, based on the overall weight of the composition;
wherein the solvent system comprises:
(A1) 2-phenoxyethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 64.0% by weight, based on the overall weight of the composition; and
(B) azoxystrobin in an amount of 36.0% by weight, based on the overall weight of the composition;
wherein the solvent system comprises:
(A1) 2-phenoxyethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:1.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) 2-phenoxy ethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:1.0.

In another embodiment, the presently claimed invention is directed to a composition (C) comprising:
(A) a solvent system in an amount of 67.0% by weight, based on the overall weight of the composition; and
(B) azoxystrobin in an amount of 33.0% by weight, based on the overall weight of the composition;
wherein the solvent system comprises:
(A1) 2-phenoxyethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 2.0:1.0.

In another embodiment, the presently claimed invention is directed to a composition (C) comprising:
(A) a solvent system in an amount of 52.0% by weight, based on the overall weight of the composition; and
(B) tebuconazole in an amount of 48.0% by weight, based on the overall weight of the composition;
wherein the solvent system comprises:
(A1) 2-phenoxy ethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 2.0:1.0.

In another embodiment, the presently claimed invention is directed to a composition (C) comprising:
(A) a solvent system in an amount of 66.0% by weight, based on the overall weight of the composition; and
(B) azoxystrobin in an amount of 34.0% by weight, based on the overall weight of the composition;
wherein the solvent system comprises:
(A1) 2-phenoxyethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:2.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) 2-phenoxy ethanol; and (A2) D,L-lactic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the D,L-lactic acid is δd 17 MPa^{1/2}, δp 8.3 MPa^{1/2}, and δh 28.4 MPa^{1/2},
wherein the mole ratio of (A1) to (A2) is 1.0:2.0.

In another embodiment, the presently claimed invention is directed to a composition (C) comprising:
(A) a solvent system in an amount of 50.0 to 80.0% by weight, based on the overall weight of the composition; and
(B) azoxystrobin in an amount of 20.0 to 50.0% by weight, based on the overall weight of the composition;
wherein the solvent system comprises:
(A1) 2-phenoxyethanol; and (A2) formic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is in the range of 1.0:2.0 to 2.0:1.0.

In another embodiment, the presently claimed invention is directed to a composition (C) comprising:
(A) a solvent system in an amount of 62.0% by weight, based on the overall weight of the composition; and
(B) azoxystrobin in an amount of 38.0% by weight, based on the overall weight of the composition;
wherein the solvent system comprises:
(A1) 2-phenoxyethanol; and (A2) formic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the presently claimed invention is directed to a composition (C) comprising:
(A) a solvent system in an amount of 50.0% by weight, based on the overall weight of the composition; and
(B) tebuconazole in an amount of 50.0% by weight, based on the overall weight of the composition;
wherein the solvent system comprises:
(A1) 2-phenoxy ethanol; and (A2) formic acid;
wherein Hansen solubility parameters of the 2-phenoxy ethanol is δd 17.8 MPa^{1/2}, δp 5.7 MPa^{1/2}, and δh 14.3 MPa^{1/2} and Hansen solubility parameters of the formic acid is δd 14.3 MPa^{1/2}, δp 11.9 MPa^{1/2}, and δh 16.6 MPa^{1/2},
wherein the mole ratio of (A1) to (A2) is 1.0:2.0.

In another embodiment, the composition (C) comprises:
(A) a solvent system in an amount of 50.0 to 80.0% by weight, based on the overall weight of the composition;
(B) tebuconazole in an amount of 20.0 to 50.0% by weight, based on the overall weight of the composition; and
(D) emulsifier (D) in an amount of 10.0 to 20.0% by weight, based on the overall weight of the composition (C)
wherein the solvent system comprises:
(A1) acetic acid and (A2) menthol;
wherein Hansen solubility parameters of the acetic acid is δd 14.5 MPa^{1/2}, δp 8 MPa^{1/2} and δh 13.5 MPa^{1/2} and Hansen solubility parameters of the menthol is δd 16.6 MPa^{1/2}, δp 4.7 MPa^{1/2}, and δh 10.6 MPa^{1/2},
wherein the mole ratio of (A1) to (A2) is in the range of 1.0:3.0 to 3.0:1.0.

In another embodiment, the composition (C) comprises:
(A) a solvent system in an amount of 63.0% by weight, based on the overall weight of the composition;
(B) tebuconazole in an amount of 25.0% by weight, based on the overall weight of the composition; and
(D) emulsifier (D) in an amount of 12.0% by weight, based on the overall weight of the composition (C)
wherein the solvent system comprises:
(A1) acetic acid and (A2) menthol;
wherein Hansen solubility parameters of the acetic acid is δd 14.5 MPa^{1/2}, δp 8 MPa^{1/2} and δh 13.5 MPa^{1/2} and Hansen solubility parameters of the menthol is δd 16.6 MPa^{1/2}, δp 4.7 MPa^{1/2}, and δh 10.6 MPa^{1/2},
wherein the mole ratio of (A1) to (A2) is 1.0:1.0.

In another embodiment, the composition (C) comprises:
(A) a solvent system in an amount of 50.0% by weight, based on the overall weight of the composition;
(B) tebuconazole in an amount of 25.0% by weight, based on the overall weight of the composition; and
(D) emulsifier (D) in an amount of 25.0% by weight, based on the overall weight of the composition (C)
wherein the solvent system comprises:
(A1) acetic acid and (A2) menthol;
wherein Hansen solubility parameters of the acetic acid is δd 14.5 MPa^{1/2}, δp 8 MPa^{1/2} and δh 13.5 MPa^{1/2} and Hansen solubility parameters of the menthol is δd 16.6 MPa^{1/2}, δp 4.7 MPa^{1/2}, and δh 10.6 MPa^{1/2},
wherein the mole ratio of (A1) to (A2) is 1.0:1.0.

In another embodiment, the composition (C) comprises:
(A) a solvent system in an amount of 55.0% by weight, based on the overall weight of the composition;
(B) tebuconazole in an amount of 25.0% by weight, based on the overall weight of the composition; and
(D) emulsifier (D) in an amount of 20.0% by weight, based on the overall weight of the composition (C)
wherein the solvent system comprises:
(A1) acetic acid and (A2) menthol;
wherein Hansen solubility parameters of the acetic acid is δd 14.5 MPa^{1/2}, δp 8 MPa^{1/2} and δh 13.5 MPa^{1/2} and Hansen solubility parameters of the menthol is δd 16.6 MPa^{1/2}, δp 4.7 MPa^{1/2}, and δh 10.6 MPa^{1/2},
wherein the mole ratio of (A1) to (A2) is 1.0:1.0.

In an embodiment, the presently claimed invention is directed to the use of a solvent system for preparing an emulsifiable concentrate comprising at least one biocide, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of the first component (A1) are different from the Hansen solubility parameters of the second component (A2); and more preferably the presently claimed invention is directed to the use of a solvent system for preparing an emulsifiable concentrate comprising at least one biocide, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:3.0 to 3.0:1.0; and
with the proviso that the Hansen solubility parameters of the first component (A1) are different from the Hansen solubility parameters of the second component (A2).

In an embodiment, the presently claimed invention is directed to a method of preparing a composition (C) comprising the steps of:
i. providing a solvent system; and
ii. adding at least one biocide to the solvent system of step i. to obtain a mixture;
wherein the solvent system comprises:
(A1) a first component selected from an organic acid (A1a) or an alcohol (A1b); and
(A2) a second component selected from an organic acid (A2a), an alcohol (A2b), an ester (A2c), or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of component (A1) are different from the Hansen solubility parameters of component (A2); more preferably the method of preparing a composition (C) comprises the steps of:
i. providing a solvent system; and
ii. adding at least one biocide to the solvent system of step i. to obtain a mixture;
wherein the solvent system comprises:
(A1) a first component selected from an organic acid (A1a) or an alcohol (A1b); and
(A2) a second component selected from an organic acid (A2a), an alcohol (A2b), an ester (A2c), or an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of component (A1) are different from the Hansen solubility parameters of component (A2).

In an embodiment, the method further comprises:
iii. heating the mixture obtained in step ii. to a temperature of 20° C. to 100° C. to obtain a heated mixture; and
iv. adding at least one emulsifier (D) to the heated mixture obtained in step iii. to obtain the composition (C).

In another preferred embodiment, the composition (C) according to the presently claimed invention is an emulsifiable composition.

In another preferred embodiment, the at least one biocide is present in an amount of 5.0 to 85.0% by weight, based on the overall weight of the composition (C); more preferably the at least one biocide is present in an amount of 10.0 to 75.0% by weight, based on the overall weight of the composition (C), even more preferably the at least one biocide is present in an amount of 15.0 to 65.0% by weight, based on the overall weight of the composition (C); most preferably the at least one biocide is present in an amount of 15.0 to 55.0% by weight, based on the overall weight of the composition (C); and in particular preferably the at least one biocide is present in an amount of 15.0 to 45.0% by weight, based on the overall weight of the composition (C).

In an embodiment, the presently claimed invention is directed to an emulsion composition (E) comprising:
a. a composition (C) in an amount in the range of 0.1 to 20.0% by weight, based on the overall weight of the emulsion composition (E); and
b. water in an amount in the range of 60.0 to 99.9% by weight based on the overall weight of the composition (E);
wherein the total amount of the composition (C) and water is in the range of 60.1 to 100% by weight based on the overall weight of the emulsion composition (E).

Yet another embodiment, the emulsion composition (E) comprising:
a. a composition (C) in an amount in the range of 0.1 to 15.0% by weight, based on the overall weight of the emulsion composition (E); and
b. water in an amount in the range of 70.0 to 99.9% by weight based on the overall weight of the composition (E);
wherein the total amount of the composition (C) and water is in the range of 70.1 to 100% by weight based on the overall weight of the emulsion composition (E) more preferably the emulsion composition (E) comprising:
a. a composition (C) in an amount in the range of 0.1 to 15.0% by weight, based on the overall weight of the emulsion composition (E); and
b. water in an amount in the range of 75.0 to 99.9% by weight based on the overall weight of the composition (E);
wherein the total amount of the composition (C) and water is in the range of 75.1 to 100% by weight based on the overall weight of the emulsion composition (E); most and in particular preferably the emulsion composition (E) comprising:
a. a composition (C) in an amount in the range of 0.1 to 15.0% by weight, based on the overall weight of the emulsion composition (E); and
b. water in an amount in the range of 80.0 to 99.9% by weight based on the overall weight of the composition (E);
wherein the total amount of the composition (C) and water is in the range of 80.1 to 100% by weight based on the overall weight of the emulsion composition (E); and in particular and in particular preferably the emulsion composition (E) comprising:
a. a composition (C) present in an amount in the range of 0.1 to 10.0% by weight, based on the overall weight of the emulsion composition (E); and
b. water in an amount in the range of 90.0 to 99.9% by weight based on the overall weight of the composition (E);
wherein the total amount of the composition (C) and water is in the range of 90.1 to 100% by weight based on the overall weight of the emulsion composition (E).

In an embodiment, the presently claimed invention is directed to a process for preparing an emulsion composition (E) comprising the steps of:
i. providing a composition (C); and
ii. adding water to the composition (C) of step i. to obtain an emulsion composition (E).

In an aspect, the presently claimed invention is directed to a use of the emulsion composition (E) for the treatment of soil and plants.

In another aspect, the presently claimed invention is directed to a method of treating soil and plants comprising the step of applying the emulsion composition (E) to the soil or plants.

In the following, there is provided a list of embodiments to further illustrate the present disclosure without intending to limit the disclosure to the specific embodiments listed below.

### EMBODIMENTS

1. A composition (C) comprising:
(A) a solvent system in an amount of 15.0 to 95.0% by weight, based on the overall weight of the composition; and
(B) at least one biocide in an amount of 5.0 to 60.0% by weight, based on the overall weight of the composition;
wherein the total amount of the solvent system (A) and the at least one biocide (B) is in the range of 20.0 to 100% by weight based on the overall weight of the composition,
wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein Hansen solubility parameters of the first component are in the ranges of δd 13-25 MPa^{1/2}, δp 2-15 MPa^{1/2} and δh 7-30 MPa^{1/2} and Hansen solubility parameters of the second component are in the ranges of δd 13-25 MPa^{1/2}, δp 1-15 MPa^{1/2}, and δh 2-30 MPa^{1/2},
wherein the mole ratio of the first component to the second component is in the range of 1.0:5.0 to 5.0:1.0; and
with the proviso that the Hansen solubility parameters of the first component (A1) are different from the Hansen solubility parameters of the second component (A2).

2. The composition (C) according to embodiment 1, wherein the composition (C) comprises
(A) the solvent system in an amount of 30.0 to 85.0% by weight, based on the overall weight of the composition; and
(B) the at least one biocide in an amount of 10.0 to 50.0% by weight, based on the overall weight of the composition;
wherein the total amount of the solvent system (A) and the at least one biocide (B) is in the range of 40.0 to 100% by weight based on the overall weight of the composition,
wherein the solvent system comprises:
(A1) the first component is selected from an organic acid (A1a) or an alcohol (A1b); and
(A2) the second component is selected from an organic acid (A2a), an alcohol (A2b), an ester (A2c) or an ether (A2d);
wherein the Hansen solubility parameters of the first component (A1) are in the ranges of δd 13-25 MPa^{1/2}, 6p 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the total amount of the first component (A1) to the total amount of the second component (A2) is in the range of 1.0:3.0 to 3.0:1.0; and with the proviso that the Hansen solubility parameters of the first component (A1) are different from the Hansen solubility parameters of the second component (A2).

3. The composition (C) according to any of the embodiments 1 to 2, wherein the total amount of the first component (A1) and the second component (A2) is in the range of 60.0 to 100% by weight based on the overall weight of the solvent system.

4. The composition (C) according to any of the embodiments 1 to 3, wherein the at least one biocide is selected from fungicide, insecticide, acaricide, rodenticide, nematicide, herbicide, or miticide.

5. The composition (C) according to any of the embodiments 1 to 4, wherein the organic acids (A1a) and (A2a) are selected from substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids.

6. The composition (C) according to any of the embodiments 1 to 5, wherein the organic acids (A1a) and (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

7. The composition (C) according to any of the embodiments 1 to 6, wherein the organic acids (A1a) and (A2a) are selected from acetic acid, formic acid, D,L-lactic acid, nonanoic acid, dodecanoic acid, hydroxy pivalic acid, or phenyl acetic acid.

8. The composition (C) according to any of the embodiments 1 to 7, wherein the organic alcohols (A1b) and (A2b) are selected from substituted or unsubstituted, linear or branched C₁-C₂₄ alkyl alcohols, substituted or unsubstituted, linear or branched C₂-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted C₇-C₂₄ arylalkyl alcohols.

9. The composition (C) according to any of the embodiments 1 to 8, wherein the organic alcohols (A1b) and (A2b) are selected from allyl alcohol, t-butyl cyclohexanol, xylitol, dextrose, 1,3-benzenediol, mannitol, 2,3-butadiene-1-ol, 1,3-butanediol, 1,4-butanediol, t-butyl alcohol, 2-phenylethanol, thymol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, ethanol, ethanolamine, 1-ethoxy ethoxy-2-propanol, 2-ethyl-1-butanol, ethylene glycol, glycerol, hexylene glycol, 3-methyl-1-butanol, isobutyl alcohol, isooctyl alcohol, methanol, menthol, carvacrol, 2-ethyl phenol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, or triethylene glycol monomethylether.

10. The composition (C) according to any of the embodiments 1 to 9, wherein the organic alcohols (A1b) and (A2b) are selected from menthol, carvacrol, 2-ethyl phenol, 1,3-benzenediol, 2-phenylethanol, thymol, 4-methyl cyclohexanol, m-cresol, cyclohexanol, 2,6-dimethyl phenol, 3,4-dimethyl phenol, o-methoxyphenol, phenol, 2-phenoxy ethanol, or cuminol.

11. The composition (C) according to any of the embodiments 1 to 10, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₁₆ alkenyl carboxylic acid, alkyl and aryl esters of substituted or unsubstituted C₅-C₂₄ cycloalkyl carboxylic acid, alkyl and aryl esters of substituted or unsubstituted C₅-024 cycloalkenyl carboxylic acid, alkyl and aryl esters of substituted or unsubstituted C₆-C₂₄ aryl carboxylic acid, or alkyl and aryl esters of substituted or unsubstituted C₇-C₂₄ arylalkyl carboxylic acid.

12. The composition (C) according to any of the embodiments 1 to 11, wherein the organic ester (A2c) is selected from butyl lactate, n-butyl salicylate, ethyl lactate, methyl salicylate, or methyl benzoate.

13. The composition (C) according to any of the embodiments 1 to 12, wherein the organic ether (A2d) has C₅-C₃₀ carbon atoms.

14. The composition (C) according to any of the embodiments 1 to 13, wherein the organic ether (A2d) is selected from triethylene glycol monomethylether, p-methoxyaniline, diethylene glycol hexylether, diethylene glycol monobutyllether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bio-(m-phenoxyphenyl) ether.

15. The composition (C) according to any of the embodiments 1 to 14, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

16. The composition (C) according to any of the embodiments 1 to 15, wherein the organic acids (A1a) and (A2a) each have Hansen solubility parameters in the ranges δd 13-25 MPa^{1/2}, δp 3-15 MPa^{1/2} and δh 10-30 MPa %.

17. The composition (C) according to any of the embodiments 1 to 16, wherein the organic alcohols (A1b) and (A2b) each have Hansen solubility parameters in the ranges δd 14.0-20 MPa^{1/2}, δp 4-12.5 MPa^{1/2} and δh 10-30 MPa %.

18. The composition (C) according to any of the embodiments 1 to 17, wherein the organic ester (A2c) has Hansen solubility parameters in the ranges δd 13-19 MPa^{1/2}, δp 3-9 MPa^{1/2}, and δh 3.5-14 MPa %.

19. The composition (C) according to any of the embodiments 1 to 18, wherein the organic ether (A2d) has Hansen solubility parameters in the ranges δd 14-20 MPa^{1/2}, δp 3-12 MPa^{1/2}, and δh 3-15 MPa %.

20. The composition (C) according to any of the embodiments 1 to 19 further comprises at least one emulsifier (D) in an amount of 1.0 to 50.0% by weight, based on the overall weight of the composition (C).

21. The composition (C) according to embodiment 20, wherein the at least one emulsifier (D) is selected from an anionic emulsifier or a non-ionic emulsifier.

22. The composition (C) according to any of the embodiments 1 to 21, wherein the composition has a viscosity in the range of 1 cp to 2000 cp at 25° C. at atmospheric pressure.

23. Use of a solvent system for preparing an emulsifiable concentrate comprising at least one biocide, wherein the solvent system comprises:
(A1) a first component selected from an organic acid (A1a) or an alcohol (A1b); and
(A2) a second component selected from an organic acid (A2a), an alcohol (A2b), an ester (A2c) or an ether (A2d);
wherein the Hansen solubility parameters of the first component (A1) are in the ranges of δd 13-25 MPa^{1/2}, 6p 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of the first component (A1) are different from the Hansen solubility parameters of the second component (A2).

24. The use according to embodiment 23, wherein the at least one biocide is selected from fungicide, insecticide, acaricide, rodenticide, nematicide, herbicide, or miticide.

25. The use according to any of the embodiments 23 to 24, wherein the organic acids (A1a) and (A2a) are selected from substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids.

26. The use according to any of the embodiments 23 to 25, wherein the organic acids (A1a) and (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

27. The use according to any of the embodiments 23 to 26, wherein the organic acids (A1a) and (A2a) are selected from acetic acid, formic acid, D,L-lactic acid, nonanoic acid, dodecanoic acid, hydroxy pivalic acid, or phenyl acetic acid.

28. The use according to any of the embodiments 23 to 27, wherein the organic alcohols (A1b) and (A2b) are selected from substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted C₇-C₂₄ arylalkyl alcohols.

29. The use according to any of the embodiments 23 to 28, wherein the organic alcohols (A1b) and (A2b) are selected from allyl alcohol, 1,3-benzenediol, 2,3-butadiene-1-ol, 1,3-butanediol, 1,4-butanediol, t-butyl alcohol, 2-phenylethanol, thymol, 4-methyl cyclohexanol, butoxyethoxy propanol, 3-butoxy butanol, m-cresol, cyclohexanol, 2-cyclopentenyl alcohol, diacetone alcohol, 2-(diethylamino)ethanol, diethylene glycol, 2,6-dimethyl phenol, 3,4-dimethyl phenol, dipropylene glycol, ethanol, ethanolamine, 1-ethoxy ethoxy-2-propanol, 2-ethyl-1-butanol, ethylene glycol, glycerol, hexylene glycol, 3-methyl-1-butanol, isobutyl alcohol, isooctyl alcohol, methanol, menthol, carvacrol, 2-ethyl phenol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, or triethylene glycol monomethylether.

30. The use according to any of the embodiments 23 to 29, wherein the organic alcohols (A1b) and (A2b) are selected from menthol, carvacrol, 2-ethyl phenol, 1,3-benzenediol, 2-phenylethanol, thymol, 4-methyl cyclohexanol, m-cresol, cyclohexanol, 2,6-dimethyl phenol, 3,4-dimethyl phenol, o-methoxyphenol, phenol, 2-phenoxy ethanol, or cuminol.

31. The use according to any of the embodiments 23 to 30, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl, or aryl esters of substituted or unsubstituted C₇-C₂₄ arylalkyl carboxylic acid.

32. The use according to any of the embodiments 23 to 31, wherein the organic ester (A2c) is selected from butyl lactate, n-butyl salicylate, ethyl lactate, methyl salicylate, or methyl benzoate.

33. The use according to any of the embodiments 23 to 32, wherein the organic ether (A2d) is ether moieties having C₅-C₃₀ carbon atoms.

34. The use according to any of the embodiments 23 to 33, wherein the organic ether (A2d) is selected from triethylene glycol monomethylether, p-methoxyaniline, diethylene glycol hexylether, diethylene glycol monobutylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether.

35. The use according to any of the embodiments 23 to 34, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

36. The use according to any of the embodiments 23 to 35, wherein the organic acids (A1a) and (A2a) each have Hansen solubility parameters in the ranges δd 13-25 MPa^{1/2}, δp 3-15 MPa % and δh 110-30 MPa %.

37. The use according to any of the embodiments 23 to 36, wherein the organic alcohols (A1b) and (A2b) each have Hansen solubility parameters in the ranges δd 14-20 MPa^{1/2}, δp 4-12.5 MPa^{1/2} and δh 10-30 MPa %.

38. The use according to any of the embodiments 23 to 37, wherein the organic ester (A2c) has Hansen solubility parameters in the ranges δd 13-19 MPa^{1/2}, δp 3-9 MPa^{1/2}, and δh 3.5-14 MPa^{1/2}.

39. The use according to any of the embodiments 23 to 38, wherein the organic ether (A2d) has Hansen solubility parameters in the ranges δd 14-20 MPa^{1/2}, δp 3-12 MPa^{1/2}, and δh 3-15 MPa^{1/2}.

40. The use according to any of the embodiments 23 to 39, wherein composition (C) further comprises at least one emulsifier (D) in an amount of 1.0 to 50.0% by weight, based on the overall weight of the composition (C).

41. The use according to embodiment 40, wherein the at least one emulsifier (D) is selected from an anionic emulsifier or a non-ionic emulsifier.

42. A method of preparing a composition (C) comprising the steps of:
i. providing a solvent system; and
ii. adding at least one biocide to the solvent system of step i. to obtain a mixture;
wherein the solvent system comprises:
(A1) a first component selected from an organic acid (A1a) or an alcohol (A1b); and (A2) a second component selected from an organic acid (A2a), an alcohol (A2b), an ester (A2c), or an ether (A2d);
wherein the Hansen solubility parameters of the first component (A1) are in the ranges of δd 13-25 MPa^{1/2}, δp 2-15 MPa % and δh 7-30 MPa % and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of component (A1) are different from the Hansen solubility parameters of component (A2).

43. The method according to embodiment 42 further comprises:
iii. heating the mixture obtained in step ii. to a temperature of 20° C. to 100° C. to obtain a heated mixture; and
iv. adding at least one emulsifier (D) to the heated mixture obtained in step iii. to obtain the composition (C).

44. The method according any of the embodiments 42 to 43, wherein the total amount of the solvent system is in the range of 60.0 to 100% by weight based on the overall weight of the composition (C).

45. The method according to any of the embodiments 42 to 44, wherein the solvent system is present in an amount of 15.0 to 85.0% by weight, based on the overall weight of the composition (C).

46. The method according to the embodiments 42 to 45, wherein the at least one biocide is present in an amount of 15.0 to 85.0% by weight, based on the overall weight of the composition (C).

47. The method according to any of the embodiments 42 to 46, wherein the at least one biocide is selected from fungicide, insecticide, acaricide, rodenticide, nematicide, herbicide, or miticide.

48. The method according to any of the embodiments 42 to 47, wherein the organic acids (A1a) and (A2a) are selected from substituted or unsubstituted, linear or branched C₁-C₂₄ alkyl carboxylic acids, substituted or unsubstituted, linear or branched C₂-C₁₆ alkenyl carboxylic acid, substituted or unsubstituted C₅-C₂₄ cycloalkyl carboxylic acid, substituted or unsubstituted C₅-C₂₄ cycloalkenyl carboxylic acid, substituted or unsubstituted C₆-C₂₄ aryl carboxylic acid, or substituted or unsubstituted C₇-C₂₄ arylalkyl carboxylic acid.

49. The method according to any of the embodiments 42 to 48, wherein the organic acids (A1a) and (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

50. The method according to any of the embodiments 42 to 49, wherein the organic acids (A1a) and (A2a) are selected from acetic acid, formic acid, D,L-lactic acid, nonanoic acid, dodecanoic acid, hydroxy pivalic acid, or phenyl acetic acid.

51. The method according to any of the embodiments 42 to 50, wherein the organic alcohols (A1b) and (A2b) are selected from substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted C₇-C₂₄ arylalkyl alcohols.

52. The method according to any of the embodiments 42 to 51, wherein the organic alcohols (A1b) and (A2b) are selected from menthol, carvacrol, 2-ethyl phenol, allyl alcohol, 1,3-benzenediol, 2,3-butadiene-1-ol, 1,3-butanediol, 1,4-butanediol, t-butyl alcohol, 2-phenylethanol, thymol, 4-methyl cyclohexanol, butoxyethoxy propanol, 3-butoxy butanol, m-cresol, cyclohexanol, 2-cyclopentenyl alcohol, diacetone alcohol, 2-(diethylamino)ethanol, diethylene glycol, 2,6-dimethyl phenol, 3,4-dimethyl phenol, dipropylene glycol, ethanol, ethanolamine, 1-ethoxy ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, or triethylene glycol monomethylether.

53. The method according to any of the embodiments 42 to 52, wherein the organic alcohols (A1b) and (A2b) are selected from menthol, cavacrol, 2-ethyl phenol, 1,3-benzenediol, 2-phenylethanol, thymol, 4-methyl cyclohexanol, m-cresol, cyclohexanol, 2,6-dimethyl phenol, 3,4-dimethyl phenol, o-methoxyphenol, phenol, 2-phenoxy ethanol, or cuminol.

54. The method according to any of the embodiments 42 to 53, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl, or aryl esters of substituted or unsubstituted C₇-C₂₄ arylalkyl carboxylic acid.

55. The method according to any of the embodiments 42 to 54, wherein the organic ester (A2c) is selected from butyl lactate, n-butyl salicylate, ethyl lactate, methyl salicylate, or methyl benzoate.

56. The method according to any of the embodiments 42 to 55, wherein the organic ether (A2d) has C₅-C₃₀ carbon atoms.

57. The method according to any of the embodiments 42 to 56, wherein the organic ether (A2d) is selected from triethylene glycol monomethylether, p-methoxyaniline, diethylene glycol hexylether, diethylene glycol monobutylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether.

58. The method according to any of the embodiments 42 to 57, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

59. The method according to any of the embodiments 42 to 58, wherein the organic acids (A1a) and (A2a) each have Hansen solubility parameters in the ranges δd 13-25 MPa^{1/2}, δp 3-15 MPa % and δh 110-30 MPa %.

60. The method according to any of the embodiments 42 to 59, wherein the organic alcohols (A1b) and (A2b) each have Hansen solubility parameters in the ranges δd 14-20 MPa^{1/2}, δp 4-12.5 MPa^{1/2} and δh 10-30 MPa %.

61. The method according to any of the embodiments 42 to 60, wherein the organic ester (A2c) has Hansen solubility parameters in the ranges δd 13-19 MPa^{1/2}, δp 3-9 MPa^{1/2}, and δh 3.5-14 MPa^{1/2}.

62. The method according to any of the embodiments 42 to 61, wherein the organic ether (A2d) has Hansen solubility parameters in the ranges δd 14-20 MPa^{1/2}, δp 3-12 MPa^{1/2}, and δh 3-15 MPa^{1/2}.

63. An emulsion composition (E) comprising:
a. a composition (C) according to any of the embodiments 1 to 22 in an amount in the range of 0.1 to 20.0% by weight, based on the overall weight of the emulsion composition (E); and
b. water in an amount in the range of 60.0 to 99.9% by weight based on the overall weight of the composition (E);
wherein the total amount of the composition (C) and water is in the range of 61.1 to 100% by weight based on the overall weight of the emulsion composition (E).

64. A process for preparing an emulsion composition (E) according to the embodiment 63 comprising the steps of:
i. providing a composition (C) according to any of the embodiments 1 to 22; and
ii. adding water to the composition (C) of step i. to obtain an emulsion composition (E).

65. Use of the emulsion composition (E) according to the embodiment 63 for the treatment of soil and plants.

66. A method of treating soil and plants comprising the step of applying the emulsion composition (E) according to the embodiment 63 to the soil or plants.

While the presently claimed invention has been described in terms of its specific embodiments, certain modifications and equivalents will be apparent to those skilled in the art and are intended to be included within the scope of the presently claimed invention

### Examples

The presently claimed invention is illustrated in detail by non-restrictive working examples which follow. More particularly, the test methods specified hereinafter are part of the general disclosure of the application and are not restricted to the specific working examples.

Methods and materials: menthol, acetic acid, cyclohexanol, D,L-Lactic acid, formic acid, hydroxy pivalic acid, methyl salicylate, 4-methylcyclohexanol, 2-phenylethanol, phenyl acetic acid, thymol, 1,2-dimethoxy benzene, 4-methoxy acetophenone, 4-isopropylbenzylalcohol, anisole, and 2-phenoxyethanol are commercially available from VWR, Sigma Aldrich and and/or BASF corporation.

Azoxystrobin is available from Taizhou Bailly Chemical Company, LTD.

Tebuconazole is available from Parchem Fine and Specialty Chemicals.

Sulfentrazone is available from Willowood.

AMD 10 is C₁₀ fatty acid dimethylamide and is available from BASF corporation.

Ar 200 ND is naphtha (petroleum), heavy aromatic-naphtahlene depleted and is available from Exxon.

CSO-36 is ethoxylated Castor Oil (POE 36) and is available from BASF corporation.

Ninate 401-A is calcium alkylbenzene sulfonate and is available from Stepan Company.

General Method of Preparing Emulsifiable Composition (C):

Component (A1) and component (A2) were mixed and heated to a temperature in the range of 20° C. to 100° C. to obtain a solution. Respective amount of the biocide was charged to the above solution at a temperature in the range of 20° C. to 100° C. to obtain the solution containing biocide. Emulsifier and other optional ingredients were charged o to the above biocide containing solution to obtain the emulsifiable composition (C).

Method for the Preparation of Emulsion:

The emulsion was prepared by mixing 0.1 to 20.0% by weight of emulsifiable composition (C) obtained above, in water.

TABLE 1
Solubility of Biocide in solvent system:

| Solvent system | | Molar ratio | Solubility wt. % in total (C) | | |
|---|---|---|---|---|---|
| Component (A1) | Component (A2) | (A1:A2) | Azoxystrobin | Tebuconazole | sulfentrazone |
| Cyclohexanol | D,L-Lactic acid | 1:2 | 20 | ND | ND |
| | | 1:1 | 20 | 47 | ND |
| Cyclohexanol | Hydroxy pivalic | 2:1 | 21 | ND | ND |
| | acid | | | | |
| Cyclohexanol | Methyl salicylate | 1:2 | ND | 38 | ND |
| 4- | Hydroxy pivalic | 2:1 | 24 | ND | ND |
| methylcyclohexanol | acid | | | | |
| 4- | Methyl salicylate | 1:2 | 20 | 35 | ND |
| methylcyclohexanol | | | | | |
| 2-phenylethanol | Phenyl acetic | 2:1 | 25 | 40 | ND |
| | acid | | | | |
| 2-phenylethanol | Methyl salicylate | 1:1 | 27 | 38 | ND |
| | | 1:2 | 25 | 35 | ND |
| | | 2:1 | 27 | 42 | ND |
| Thymol | Phenyl acetic | 2:1 | 60 | 36 | ND |
| | acid | | | | |
| 2-phenylethanol | Formic acid | 1:1 | ND | 40 | ND |
| | | 1:2 | 20 | 40 | ND |
| | | 2:1 | 20 | 35 | ND |
| 2-phenylethanol | D,L-Lactic acid | 1:1 | 25 | 38 | ND |
| | | 2:1 | 22 | 38 | 20 |
| formic acid | Methyl salicylate | 2:1 | 40 | 50 | ND |
| | | 1:2 | 27 | 50 | 25 |
| D,L-Lactic acid | 1,2-dimethoxy | 2:1 | 32 | 40 | ND |
| | benzene | | | | |
| D,L-Lactic acid | 4-isopropylbenzyl | 2:1 | 33 | 40 | ND |
| | alcohol | | | | |
| 4- | Phenyl acetic | 2:1 | 24 | 40 | ND |
| isopropylbenzylalcohol | acid | | | | |
| Formic acid | 1,2-dimethoxy | 2:1 | 49 | 50 | ND |
| | benzene | | | | |
| 2-phenoxyethanol | D,L-Lactic acid | 1:1 | 36 | 50 | ND |
| Thymol | (L)-menthol | 1:1 | 28 | ND | ND |
| 4-Nitrophenol | (L)-menthol | 1:2.3 | [symbol] | ND | ND |
| 2-phenoxyethanol | D,L-lactic acid | 1:2 | 20 | ND | ND |
| 2-phenylethanol | Methyl salicylate | 1:2 | 24 | ND | ND |
| | | 2:1 | 23 | ND | ND |
| Carvacrol | 2-ethylphenol | 1:2 | <49 | | |
| 2-phenoxyethanol | Methyl salicylate | 1:1 | 19 | | |
| D,L-Lactic acid | 4-acetylanisole | 2:1 | 22 | | |
| D,L-Lactic acid | Veratrole | 2:1 | 24 | | |
| D,L-Lactic acid | 2- | 1:1 | 23 | | |
| | phenoxyethanol | | | | |
| 2-phenoxyethanol | Veratrole | 2:1 | 23 | | |

TABLE 2
Solubility of mesotrione in the solvent system:

| | | | Solubility wt. % |
|---|---|---|---|
| Solvent system | | Molar | in total (C) |
| Component (A1) | Component (A2) | ratio (A1:A2) | Mesotrione |
| Thymol | Phenyl acetic | 2:1 | 20 |
| | acid | | |

ND—not done

TABLE 3
comparative examples

| Solvent system | Solubility 20 wt. % in solvent | | |
|---|---|---|---|
| (1 mole) | Azoxystrobin | Tebuconazole | sulfentrazone |
| Methyl Salicylate | NS | NS | NS |
| 2-Phenyl ethanol | NS | NS | NS |
| Cyclohexanol | NS | NS | NS |
| 4-Methyl cyclohexanol | NS | NS | NS |
| D,L-Lactic acid | NS | NS | NS |

NS—not soluble

Example 2: The emulsifiable concentrate was prepared by dissolving tebuconazole (25 wt. %) in a solvent system (63 wt. %) of menthol and acetic acid (1:1 molar ratio). To above solution 030-36 (10 wt. %) and Ninate 401-A (2 wt. %) were added and stirred to obtain the emulsifiable concentrate.

Example 1 was repeated similarly replacing the solvent system. Examples 2 and 3 were repeated similar to example 1.

TABLE 4
Emulsifiable concentrate

| | Comp. 1 | Ex. 1 | Ex. 2 | Ex. 3 |
|---|---|---|---|---|
| Tebuconazole, wt. % | 25 | 25 | 25 | 25 |
| AMD 10 (53 wt. %):Ar 200 | 63 | 0 | 0 | 0 |
| ND (10 wt. %) | | | | |
| Menthol:Acetic Acid | 0 | 63 | 50 | 55 |
| (1:1 molar ratio)wt. % | | | | |
| CSO-36, wt. % | 10 | 10 | 20 | 17.5 |
| Ninate 401-A, wt. % | 2 | 2 | 5 | 2.5 |

TABLE 5
The three components solvent system

| | Molar | Solubility of |
|---|---|---|
| | ratio of | Azoxystrobin wt. |
| Solvent system | solvents | % in total (C) |
| 2-Phenoxyethanol:Veratrole:D,L-Lactic | 1:1:2 | 21 |
| acid | | |
| 2-Phenoxyethanol:Methyl salicylate:D,L- | 1:1:2 | 29 |
| Lactic acid | | |
| 2-Phenoxyethanol:Methyl Salicylate:Water | 1:1:0.5 | 24 |
| (tap) | | |
| 2-Phenoxyethanol:Veratrole:Water (tap) | 1:2:0.5 | 25 |
| 2-Phenylethanol:phenyl acetic acid:Water | 2:1:0.5 | 25 |
| (tap) | | |
| 2-Phenylethanol:Methyl Salicylate:Water | 1:1:0.5 | 25 |
| (tap) | | |

It is evident from table 1 to 5 that the biocides can be solubilised in a combination of at least one component (A1) and at least one component (A2) and which can be further formulated to stable emulsion concentrate. It can be inferred from table 4 that the tebuconazole can be formulated to an emulsifiable concentrate compared to suspension concentrate or emulsion concentrate in aromatic solvent system. Further, table 5 discloses that a three components solvent system also aids in solubilizing the biocides or adding water to two-components solvent system can improve the solubility of the biocide(s).

1. A composition (C) comprising:
(A) a solvent system in an amount of 15.0 to 95.0% by weight, based on the overall weight of the composition; and
(B) at least one biocide selected from the group consisting of fungicide, insecticide, acaricide, rodenticide, nematicide, herbicide, and miticide in an amount 5.0 to 60.0% by weight, based on the overall weight of the composition;
wherein the total amount of the solvent system (A) and the at least one biocide (B) is in the range of 20.0 to 100% by weight based on the overall weight of the composition,
wherein the solvent system comprises:
(A1) a first component selected from the group consisting of an organic acid (A1a) and an alcohol (A1b); and
(A2) a second component selected from the group consisting of an organic acid (A2a), an alcohol (A2b), an ester (A2c) and an ether (A2d);
wherein Hansen solubility parameters of the first component (A1) are in the ranges of δd 13-25 MPa^{1/2}, δp 2-15 MPa^{1/2} and δh 7-30 MPa^{1/2} and Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of the first component (A1) are different from the Hansen solubility parameters of the second component (A2).

2. The composition (C) according to claim 1, wherein the composition (C) comprises
(A) the solvent system in an amount of 30.0 to 85.0% by weight, based on the overall weight of the composition; and
(B) the at least one biocide selected from the group consisting of fungicide, insecticide, acaricide, rodenticide, nematicide, herbicide, and miticide in an amount of ≥15.0 to ≤50.0% by weight, based on the overall weight of the composition;
wherein the total amount of the solvent system (A) and the at least one biocide (B) is in the range of 45.0 to 100% by weight based on the overall weight of the composition,
wherein the solvent system comprises:
(A1) the first component selected from the group consisting of an organic acid (A1a) and an alcohol (A1b); and
(A2) the second component selected from an organic acid (A2a), an alcohol (A2b), an ester (A2c) and an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the total amount of the first component (A1) to the total amount of the second component (A2) is in the range of 1.0:3.0 to 3.0:1.0; and
with the proviso that the Hansen solubility parameters of the first component (A1) are different from the Hansen solubility parameters of the second component (A2).

3. (canceled)

4. (canceled)

5. The composition (C) according to claim 1, wherein the organic acids (A1a) and (A2a) are selected from the group consisting of substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, and substituted or unsubstituted C₇-C₂₄ arylalkyl carboxylic acids.

6. (canceled)

7. (canceled)

8. The composition (C) according to claim 1, wherein the organic alcohols (A1b) and (A2b) are selected from the group consisting of substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, and substituted C₇-C₂₄ arylalkyl alcohols.

9. (canceled)

10. (canceled)

11. The composition (C) according to claim 1, wherein the organic ester (A2c) is selected from the group consisting of alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, and alkyl or aryl esters of substituted or unsubstituted C₇-C₂₄ arylalkyl carboxylic acid.

12. (canceled)

13. The composition (C) according to claim 1 wherein the organic ether (A2d) has C₅-C₃₀ carbon atoms.

14. (canceled)

15. (canceled)

16. The composition (C) according to claim 1, wherein the organic acids (A1a) and (A2a) each have Hansen solubility parameters in the ranges δd 13-25 MPa^{1/2}, δp 3-15 MPa^{1/2} and δh 10-30 MPa^{1/2}, the organic alcohols (A1b) and (A2b) each have Hansen solubility parameters in the ranges δd 14.0-20 MPa^{1/2}, δp 4-12.5 MPa^{1/2} and δh 10-30 MPa^{1/2}, the organic ester (A2c) has Hansen solubility parameters in the ranges δd 13-19 MPa^{1/2}, δp 3-9 MPa^{1/2}, and δh 3.5-14 MPa^{1/2}, the organic ether (A2d) has Hansen solubility parameters in the ranges δd 14-20 MPa^{1/2}, δp 3-12 MPa^{1/2}, and δh 3-15 MPa^{1/2}.

17. (canceled)

18. (canceled)

19. (canceled)

20. The composition (C) according to claim 1 further comprising at least one emulsifier (D) selected from the group consisting of an anionic emulsifier and a non-ionic emulsifier, in an amount of 1.0 to 50.0% by weight, based on the overall weight of the composition (C).

21. (canceled)

22. The composition (C) according to claim 1, wherein the composition has a viscosity in the range of 1 cp to 2000 cp at 25° C. at atmospheric pressure.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A method of preparing a composition (C) comprising the steps of:
i. providing a solvent system; and
ii. adding at least one biocide selected from the group consisting of fungicide, insecticide, acaricide, rodenticide, nematicide, herbicide, and miticide to the solvent system of step i. to obtain a mixture;
wherein the solvent system comprises:
(A1) a first component selected from the group consisting of an organic acid (A1a) and an alcohol (A1b); and
(A2) a second component selected from the group consisting of an organic acid (A2a), an alcohol (A2b), an ester (A2c), and an ether (A2d);
wherein the Hansen solubility parameters of the first component (A1) are in the ranges of δd 13-25 MPa^{1/2}, δp 2-15 MPa^{1/2} and δh 7-30 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of the first component (A1) to the second component (A2) is in the range of 1.0:5.0 to 5.0:1.0; and
with the proviso that the Hansen solubility parameters of component (A1) are different from the Hansen solubility parameters of component (A2).

43. The method according to claim 42 further comprising:
iii. heating the mixture obtained in step ii. to a temperature of 20° C. to 100° C. to obtain a heated mixture; and
iv. adding at least one emulsifier (D) to the heated mixture obtained in step iii. to obtain the composition (C).

44. The method according to claim 42, wherein the total amount of the solvent system is in the range of 60.0 to 100% by weight based on the overall weight of the composition (C).

45. (canceled)

46. The method according to claim 42, wherein the at least one biocide is present in an amount of 15.0 to 85.0% by weight, based on the overall weight of the composition (C).

47. (canceled)

48. The method according to claim 42, wherein the organic acids (A1a) and (A2a) are selected from the group consisting of substituted or unsubstituted, linear or branched C₁-C₂₄ alkyl carboxylic acids, substituted or unsubstituted, linear or branched C₂-C₁₆ alkenyl carboxylic acid, substituted or unsubstituted C₅-C₂₄ cycloalkyl carboxylic acid, substituted or unsubstituted C₅-C₂₄ cycloalkenyl carboxylic acid, substituted or unsubstituted C₆-C₂₄ aryl carboxylic acid, and substituted or unsubstituted C₇-C₂₄ arylalkyl carboxylic acid.

49. (canceled)

50. (canceled)

51. The method according to claim 42, wherein the organic alcohols (A1b) and (A2b) are selected from the group consisting of substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, and substituted C₇-C₂₄ arylalkyl alcohols.

52. (canceled)

53. (canceled)

54. The method according to claim 42, wherein the organic ester (A2c) is selected from the group consisting of alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, and alkyl, or aryl esters of substituted or unsubstituted C₇-C₂₄ arylalkyl carboxylic acid.

55. (canceled)

56. The method according claim 42, wherein the organic ether (A2d) has C₅-C₃₀ carbon atoms.

57. (canceled)

58. (canceled)

59. The method according to claim 42, wherein the organic acids (A1a) and (A2a) each have Hansen solubility parameters in the ranges δd 13-25 MPa^{1/2}, δp 3-15 MPa^{1/2} and δh 10-30 MPa^{1/2}, the organic alcohols (A1b) and (A2b) each have Hansen solubility parameters in the ranges δd 14-20 MPa^{1/2}, δp 4-12.5 MPa^{1/2} and δh 10-30 MPa^{1/2}, the organic ester (A2c) has Hansen solubility parameters in the ranges δd 13-19 MPa^{1/2}, δp 3-9 MPa^{1/2}, and δh 3.5-14 MPa^{1/2} and the organic ether (A2d) has Hansen solubility parameters in the ranges δd 14-20 MPa^{1/2}, δp 3-12 MPa^{1/2}, and δh 3-15 MPa^{1/2}.

60. (canceled)

61. (canceled)

62. (canceled)

63. An emulsion composition (E) comprising:
a. a composition (C) according to claim 1 in an amount in the range of 0.1 to 20.0% by weight, based on the overall weight of the emulsion composition (E); and
b. water in an amount in the range of 60.0 to 99.9% by weight based on the overall weight of the composition (E);
wherein the total amount of the composition (C) and water is in the range of 61.1 to 100% by weight based on the overall weight of the emulsion composition (E).

64. A process for preparing an emulsion composition (E) according to the claim 63 comprising the steps of:
i. providing a composition (C) according claim 1; and
ii. adding water to the composition (C) of step i. to obtain an emulsion composition (E).

65. (canceled)

66. A method of treating soil and plants comprising the step of applying the emulsion composition (E) according to the claim 63 to the soil or plants.
